(19) United States
(12) Patent Application Publication
(10) Pub. No.: US 2020/0063460 A1
(43) Pub. Date: Feb. 27, 2020

(54) MOBILE COMPTUING DEVICE SOFTWARE APPLICATION INTERFACING WITH AUTOMATION ATTACHMENT

(71) Applicant: SHADECRAFT, INC., Pasadena, CA (US)

(72) Inventor: ARMEN GHARABEGIAN, GLENDALE, CA (US)

(73) Assignee: SHADECRAFT, INC.

(21) Appl. No.: 16/271,819

(22) Filed: Feb. 9, 2019

Related U.S. Application Data
(63) Continuation of application No. 16/178,798, filed on Nov. 2, 2018.
Application No. 16/178,798 is a continuation of application No. 16/231,485, filed on Dec. 22, 2018.
(60) Provisional application No. 62/789,525, filed on Jan. 8, 2019.
(60) Provisional application No. 62/723,463, filed on Aug. 27, 2018.
(60) Provisional application No. 62/720,877, filed on Aug. 21, 2018.

(51) Int. Cl. E04H 15/02; G06F 3/16; H04R 1/02; E04H 15/28; G01D 11/24; H04N 5/232; H04N 5/225; E04H 15/10; B66D 1/12

(52) U.S. Cl. CPC E04H 15/02; G06F 3/165; H04R 1/028; E04H 15/28; H04W 4/80; H04N 5/232; H04N 5/2253; E04H 15/10; B66D 1/12; G01D 11/245

(57) ABSTRACT

An automatically controlled umbrella system includes an existing non-automated umbrella including an umbrella base, an umbrella pole and an umbrella frame; an automation attachment connected to the umbrella frame to automate the opening or closing of the umbrella frame; and a mobile computing device, the mobile computing device comprising processor(s); memory device(s); wireless communication transceiver(s); and computer-readable instructions stored in the memory device(s), the computer-readable instructions executable by the processor(s) to communicate instructions, commands or messages to the automation attachment via the wireless communication transceiver(s) to open or close the umbrella frame. The automation attachment includes processor(s), memory device(s) and computer-readable instructions stored in the memory device(s), the computer-readable instructions executable by the processor(s) to control operation of the automation attachment.

### RELATED APPLICATIONS

This application claims priority to U.S. provisional patent application Ser. No. 62/789,525, filed Jan. 8, 2019, and is also a continuation-in-part of U.S. non-provisional patent application Ser. No. 16/178,798, filed Nov. 2, 2018, and is a continuation-in-part of U.S. non-provisional patent application Ser. No. 16/231,485, filed Dec. 22, 2018, both of which claim priority to U.S. provisional patent application Ser. No. 62/723,463, filed Aug. 27, 2018 and U.S. provisional patent application Ser. No. 62/720,877, filed Aug. 21, 2018, the disclosures of which are hereby incorporated by reference.

### BACKGROUND

Many existing umbrellas or shading systems utilize a rope and pulley system in order to open an umbrella. For example, FIG. 1 illustrates an existing umbrella having a hand crank, a pulley system and a string according to the prior art. Prior umbrellas have at least a tubular support, a hand crank assembly, one or more strings, at least a two pulley system, a circular support assembly, and one or more arms or an umbrella support frame. A hand crank assembly is connected to the one or more strings. The strings wrap around a first pulley of a pulley system, where the first pulley may be within a tubular support assembly or attached to an outside surface of a tubular support assembly. The string extends around a second pulley or wheel of the pulley system, the second pulley or wheel is located at a higher vertical location than the first pulley system. The string may be connected to a circular arm collar assembly. When the hand crank is turned, it pulls a string or rope which moves about the pulley system and pulls the circular arm collar assembly in a vertical direction (e.g., upward), which causes the frame and/or arms connected to the circular arm support to open and expand the parasol so that the shade is deployed. However, this two-pulley system requires manual operation by having an operator pull on a string. In addition, these umbrellas do not have any intelligent features and cannot interact with operators and/or users. In addition, the pulleys and cranks come with the umbrella and are part of the system.

### BRIEF DESCRIPTION OF THE DRAWINGS

FIG. 1 illustrates an existing manual umbrella according to the prior art;

FIG. 2 illustrates a manual umbrella including an attachment to automate and provide additional features for the manual umbrella according to embodiments;

FIG. 2B illustrates a pulley and motor assembly according to embodiments.

FIG. 3A illustrates a top view of an automation attachment connected to a center support assembly according to embodiments;

FIG. 3B illustrates a top view of an automation attachment including couplers or adapters to allow the automation attachment to connect to center support assemblies having various diameters according to embodiments;

FIG. 3C illustrates an automation attachment split into two panels on an existing parasol center pole according to embodiments;

FIG. 3D illustrates additional locking systems according to embodiments;

FIG. 3E illustrates a new version of a locking system according to embodiments.

FIG. 4 illustrates a main processor module according to embodiments;

FIG. 5 illustrates an environmental sensor assembly or sensor assembly according to embodiments;

FIG. 6A illustrates a block diagram of a speaker assembly according to embodiments;

FIG. 6B illustrates a speaker assembly including a speaker and a passive radiator in a section of an automation attachment according to embodiments;

FIG. 7 illustrates a block diagram of one or more lighting assemblies according to embodiments;

FIG. 8 illustrates an automation attachment including sensors to monitor movement of an umbrella, parasol or shading system according to embodiments;

FIG. 9A illustrates a block diagram of an automation assembly according to embodiments;

FIG. 9B illustrates a front view of an automation attachment according to embodiments;

FIG. 9C illustrates a side view of an automation attachment according to embodiments;

FIG. 9D illustrates an automation attachment attached to an umbrella or parasol according to embodiments;

FIG. 9E illustrates an automation attachment attached to an umbrella including an elevation joint or hinge according to embodiments; and

FIG. 10 illustrates bidirectional communication between a mobile computing device and an automation attachment according to embodiments.

### DETAILED DESCRIPTION OF THE INVENTION

Claimed subject matter is directed to an apparatus that automates the opening and closing of prior art non-automated and/or manual umbrellas or parasols. Claimed subject matter is also directed an apparatus that provides intelligence and automation to the non-automated and/or manual umbrellas or parasols, such as environmental sensors, directional sensors, voice activation and/or audio systems.

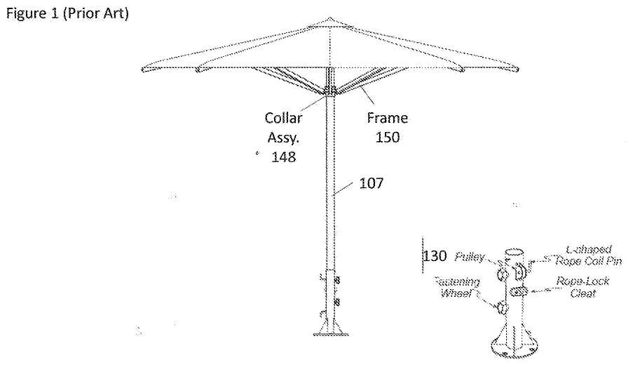

FIG. 1 illustrates an existing manual umbrella according to the prior art. In embodiments, an existing umbrella 100 may comprise a base assembly 105, a center support assembly 107, an arm or frame hub assembly 148, one or more arm support assemblies or frame 150. Although FIG. 1 does not show this, the umbrella frame may be replaced with one or more arms or blades. In embodiments, an existing manual umbrella 100 may open or close by having a rope or cable attached to an arm or frame hub assembly (or collar assembly) 148. In embodiments, a user or operator may pull on a rope or cable to cause the arm collar assembly 148 to move in an upward vertical direction. This results in movement or expansion of the one or more arm support assemblies or frame 150 (as well as the one or more arms in other embodiments) and thus opening of the umbrella. Once the umbrella's frame 150 is open, the rope may be attached to a hole in the center support assembly 107 or to a connector that allows the rope or cable to be tied thereto and held in position. In embodiments, the rope or cable may be attached to a top surface of the arm collar assembly or 148 and may pull in the upward vertical direction. In order to close the existing manual umbrella 100 or retract the frame 150 (or arms in other embodiments), a user or operator would untie the ropes and let gravity allow the rope (via the pulley assembly) to release and cause the arm collar assembly 148 to move in a downward vertical direction to a resting position. In this illustrative embodiment, no hand crank may be utilized and a rope may be wound around one or more pulley assemblies and attached to arm hub assembly (or collar) 148. The rope may be pinned or attached to the center support assembly 107 or to an attachment to the center support assembly 107. In this configuration, a user or operator may just pull directly on the rope or cable to raise or lower the arm assembly (or collar) 148 and to expand or retract the frame 150 (or arms in other embodiments). In embodiments, one or more ropes or cables may be utilized along with one or more pulley assemblies 130 to attach to different portions of the arm hub assembly or collar 148 to allow for more power and stability (e.g., by pulling on opposite sites) in pulling the arm hub assembly or collar 148 in an upward direction and/or releasing the arm hub assembly or collar 148. In embodiments, for example, when only a rope or cable and pulley assembly 130 are utilized, one or more pulley assemblies may be located above the arm assembly or collar and the rope may be tied off to one or the arm support assemblies or to an attachment on the center support assembly.

In embodiments, an existing umbrella 100 may also include a pulley assembly, a hand crank, an attachment mechanism and/or a rope or a cable. In embodiments, a hand crank may be attached a driving assembly and a driving assembly may be connected to a pulley assembly. In embodiments, rotation or turning of the hand crank results in a driving assembly causing a portion of a pulley assembly to rotate. In embodiments, a rope or cable may be attached to a pulley assembly. In embodiments, one or more pulley assemblies may need to be used depending on the height or length or the existing manual umbrella 107. For example, for a tall umbrella, two or more pulley assemblies may be utilized by the umbrella. This may be utilized for example, when a hand crank mechanism is utilized.

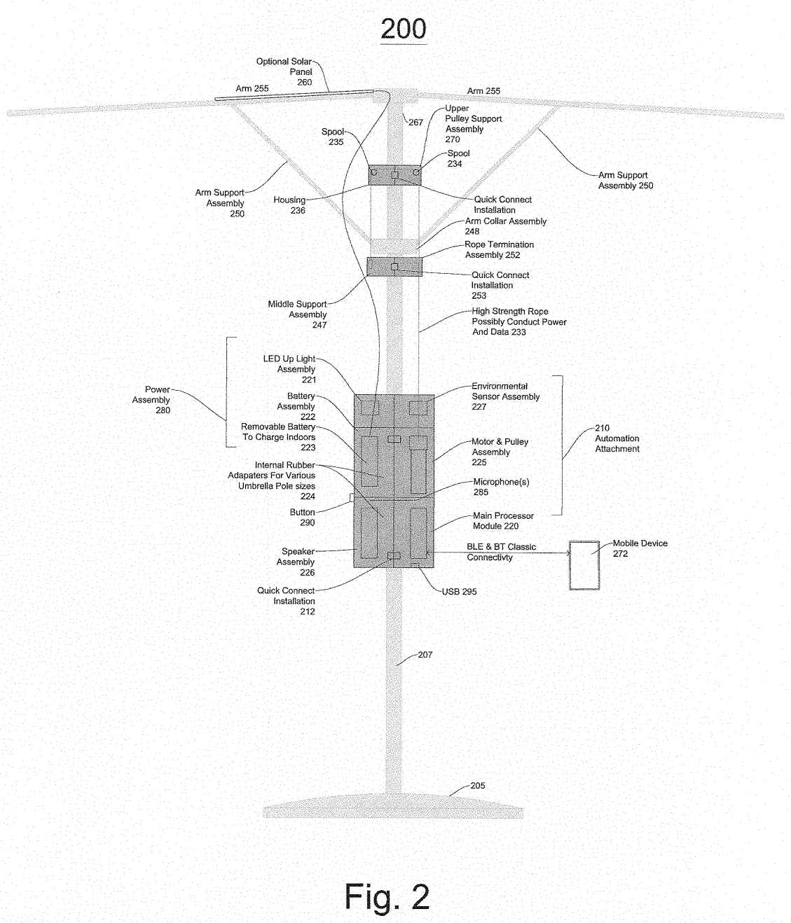

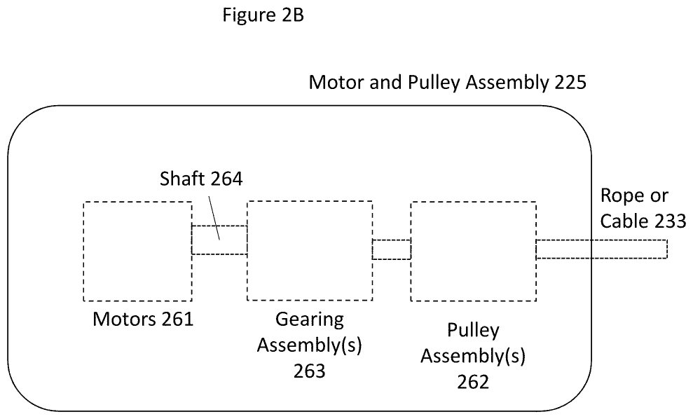

FIG. 2 illustrates a manual or existing umbrella, parasol or shading system including an automation attachment to automate and provide additional features for an manual umbrella according to embodiments. In embodiments, an attachment to an umbrella 200 may be referred to as an automation attachment 210. In embodiments, a manual or existing umbrella, parasol or shading system 200 may comprise a base assembly 205, a center support assembly 207, an automation attachment 210, an arm hub or collar assembly 248, one or more arm support assemblies 250, and/or one or more arms 255. Although FIG. 2 illustrates an umbrella with arms, an automation attachment 210 may also be utilized on umbrellas where a support frame (or spokes of a support frame) are connected to the arm hub or collar assembly 248 and where the support frame is utilized to open or close and/or also to support a parasol cover (rather than utilizing the arm support assemblies and arms and parasol or umbrella cover).

In embodiments, the automation attachment 210 may be attached, coupled or connected to the center support assembly 207. In embodiments, one or more installation connectors 212 may be utilized and may be referred to as quick installation connectors. In embodiments, the one or more installation connectors 212 may be pins that attach to holes in the center support assembly 207. In embodiments, the one or more installation connectors 212 may be adhesive connectors, suction connectors and/or magnetic connectors.

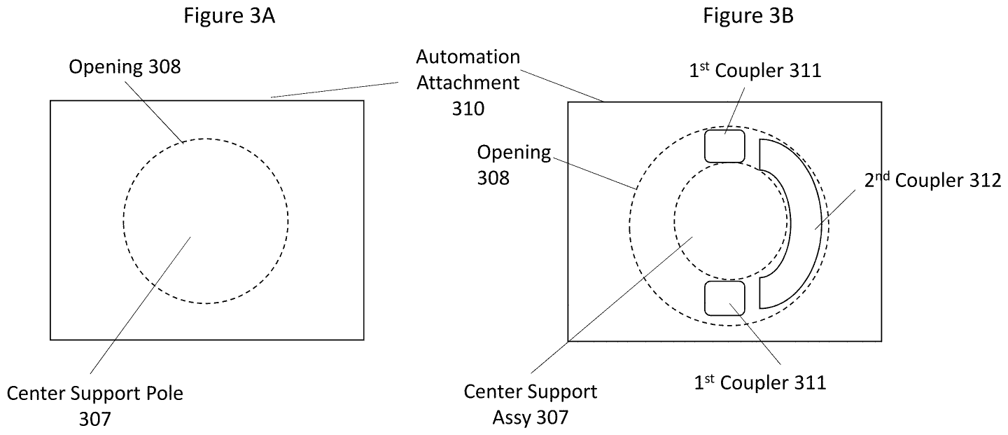

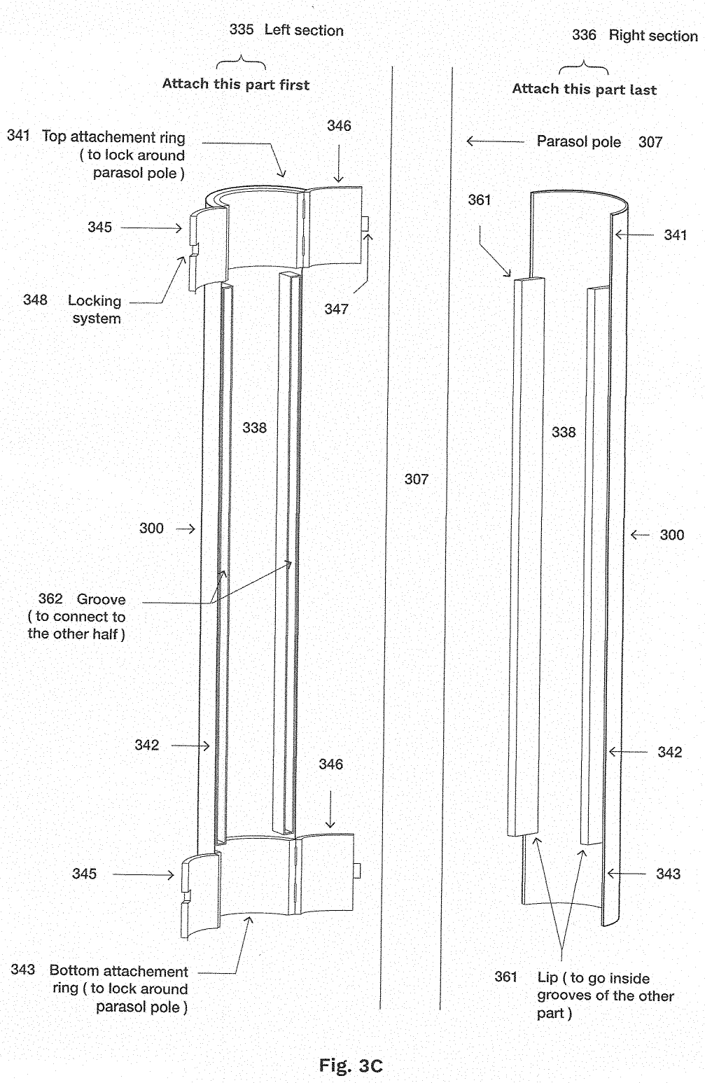

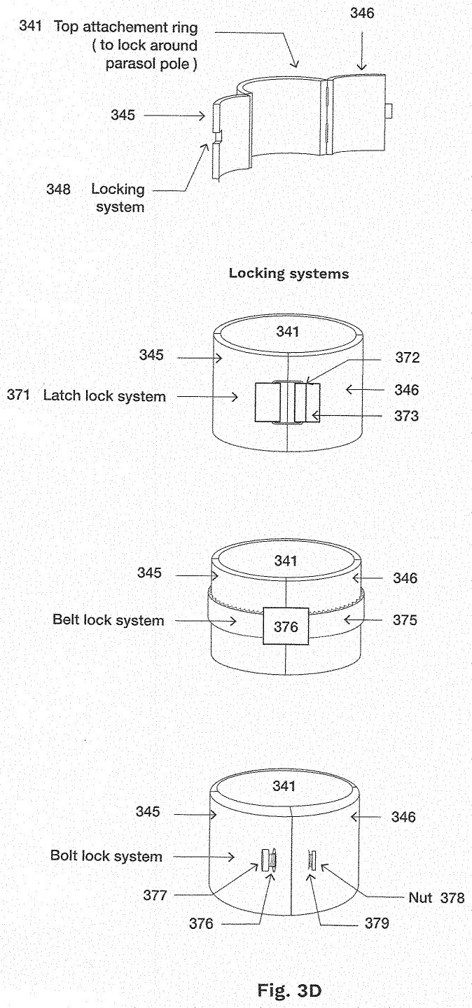

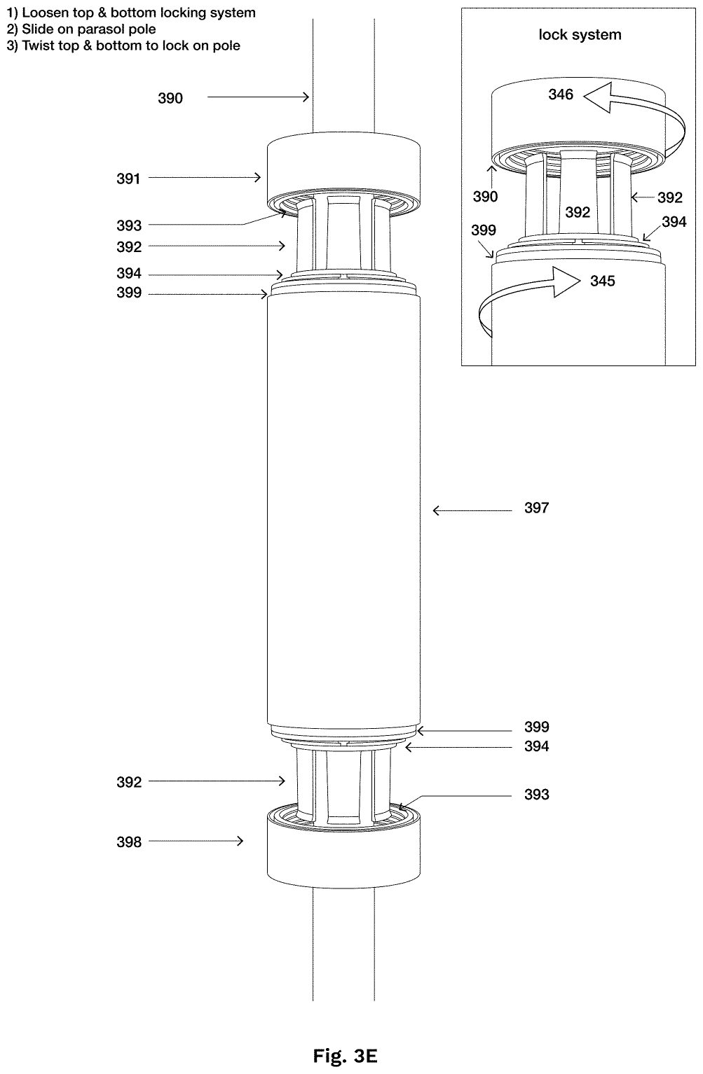

FIG. 3A illustrates a top view of an automation attachment connected to a center support assembly according to embodiments. FIG. 3B illustrates a top view of an automation attachment including couplers or adapters to allow the automation attachment to connect to center support assemblies having various diameters according to embodiments. Existing umbrellas typically have pole diameters ranging from one inches to two and one-half inches. In embodiments, an automation attachment 310 may be rectangular, oval, circular or other geometric shapes and may have a circular opening 308 that is close to or slightly larger than a diameter of a center support assembly 307, as shown in FIG. 3A. In embodiments, an automation attachment 310 may have a circular opening 308 that is larger than a diameter of a center support assembly 307. In this illustrative embodiment, one or more couplers and/or adapters may be utilized to bridge the difference and to have the circular opening 308 couple to, attach to connect to and/or, press against the center support assembly 307 of the umbrella. In embodiments, the couplers and/or adapters 311 or 312 may be made of rubber, may be push pins, may be magnetic, may include adhesives and/or may include screws and/or nuts or bolts. In embodiments, the use of the couplers and/or adapters 311 or 312 may allow the automation attachment 310 to be coupled to a wide variety of manual umbrella center support assemblies 307. This is not available in the marketplace at the present time. In addition, it is a significant improvement because automation attachment 310 on one size may be utilized for the existing umbrellas without significant modifications. FIG. 2 illustrates potential vertical locations of the one or more couplers and/or adapters in an automation attachment 210 (the one or more couplers or adapters may be in similar locations to the locations show as quick connect assemblies 212 in FIG. 2. FIG. 3B illustrates two example embodiments of couplers. For example, two couplers or adapters 311 may be utilized to press and hold the automation attachment against the center support assembly 307. For example, coupler 312 may take up more of the space formed between the automation attachment opening 308 and the center support assembly 307. In embodiments, multiple couplers may be utilized (e.g., two or more couplers or adapters 311 or more than one coupler 312).

FIG. 3C illustrates an automation attachment split into two panels on an existing parasol center pole according to embodiments. In embodiments, an automation attachment 300 may be wrapped around a center support assembly 307 or may be coupled or connected to the center support assembly 307. In embodiments, an automation attachment 300 may comprise two sections, a left horizontal section 335 and/or a right horizontal section 336. Although FIG. 3C illustrates an automation attachment 300 with two sections, the automation attachment 300 may comprise three sections, four sections or a plurality of sections, each which may be fit together to attach to, couple to and/or connect to a center support assembly 305. In embodiments, as illustrated in FIG. 3C, a left horizontal section 335 and/or a right horizontal section 336 include a top section 341, a middle section 342 and a bottom section 343. In embodiments, a left horizontal section 335 and/or a right horizontal section 336 may each be formed on one piece utilizing additive manufacturing techniques. This provides the advantage of being easily modifiable in case changes need to be made. Also, by having the left horizontal section 335 and/or a right horizontal section 336 one piece, this provides strength and prevents the automation attachment from being easily damaged. In embodiments, a top section 341 and/or a bottom section 343 may be separate pieces and may be attached or coupled to the center section.

In embodiments, the left horizontal section 335 and the right horizontal section 336 may comprise a hollow concave portion 338 (shown in the left horizontal section 335). In embodiments, a hollow concave portion 338 is what allows the automated attachment 300 to have an opening (e.g., a circular opening) to allow the existing parasol center support assembly (or pose) 307 to pass through the automation attachment 300. In embodiments, one section of the automation attachment 300 may comprise a rechargeable power source and data cables and/or power cables may transfer power to the other section of the automation attachment 300. In embodiments, the left horizontal section 336 and/or the right horizontal section 336 may each comprise one or more channels. In embodiments, the one or more channels may allow power cables or data cables to travel from one horizontal section to the other horizontal section. In embodiments, the one or more channels on a left horizontal section 335 may be opposing or opposite to one or more channels on a right horizontal section 336 to allow for the holes to fit into one another.

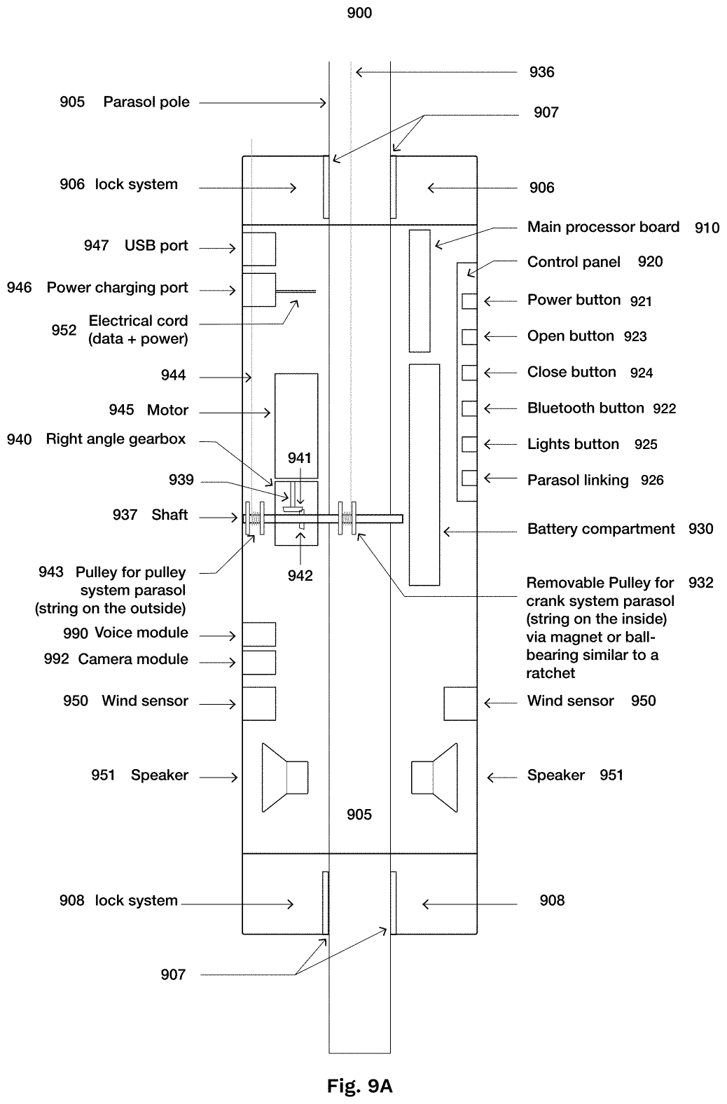

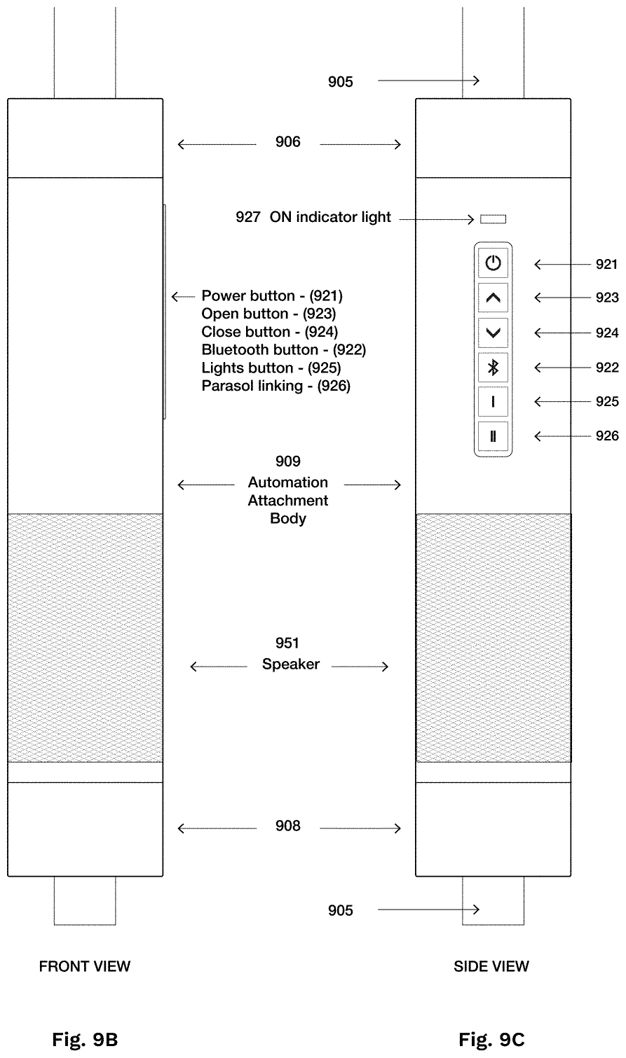

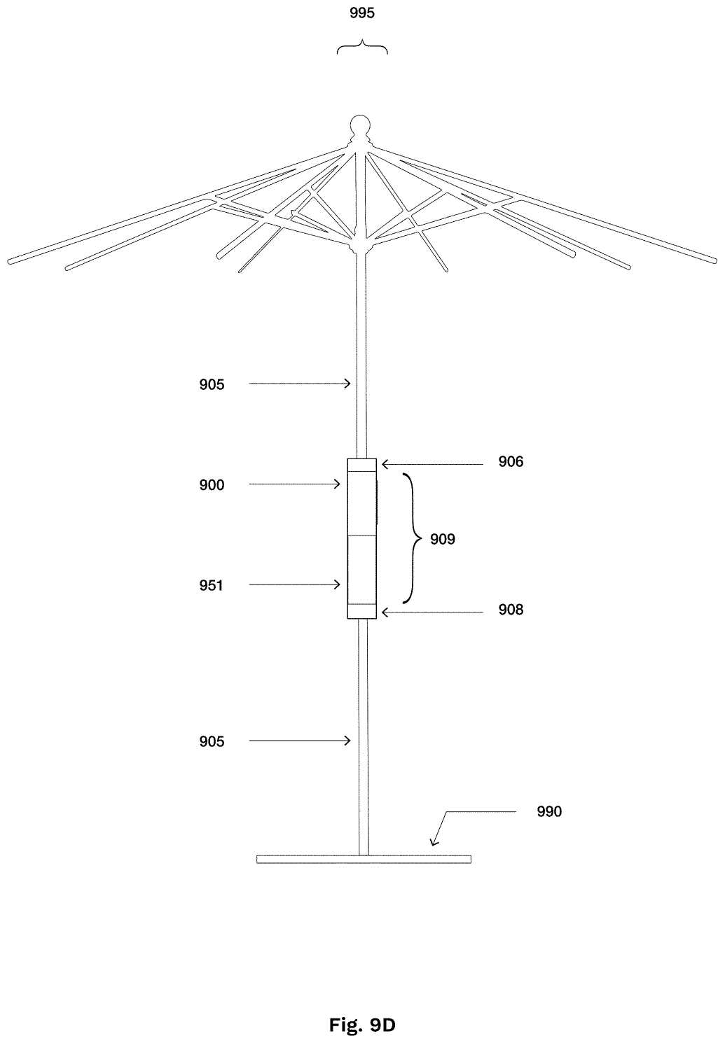

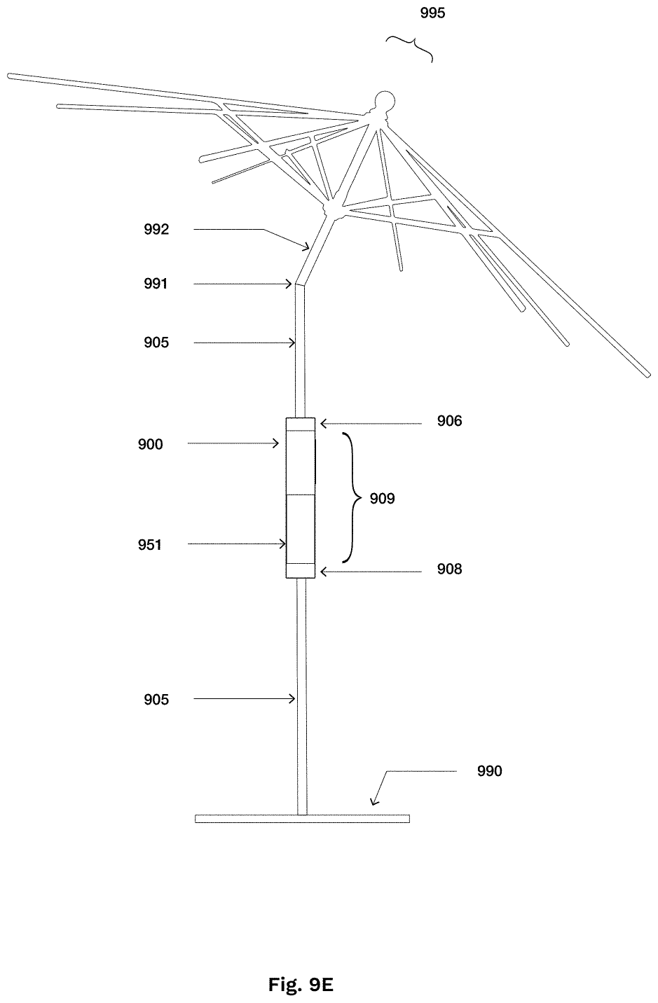

In embodiments, a middle section 342 of one horizontal section (e.g., the right horizontal section 336 in FIG. 9B) of the automation attachment may also comprise two lips or ridges 361 (which may be vertical ridges running from a top part of a middle section to a bottom part of a middle section 342). In embodiments, a middle section 342 of the other horizontal section (e.g., the left horizontal section 335 in FIG. 3B) of the automation attachment 300 may comprise two grooves or recesses 362 running from a top part of a middle section to a bottom part of a middle section 342). In embodiments, the two internal edges, lips or ridges 361 may fit into and/or connect to the openings, grooves or recesses 362 in the other horizontal section of the automation attachment in order to connect the two halves of the automation attachment together. Although FIG. 3C illustrates two halves of an automation attachment 300, the automation attachment may comprise three or more pieces where each section may have edges, lips or ridges and also openings, grooves or recesses to allow connection or coupling of the three or more pieces.

In embodiments, one of the top sections 341 and/or one of the bottom sections 341 of the left horizontal section 335 and the right horizontal section 336 may also include two adjustment flanges or assemblies 345 and 346 to be utilized as a locking assembly. In embodiments, the two adjustment flanges or assemblies 345 and 346 may allow the automation attachment 300 to adjust to different diameters of umbrella or parasol central support poles 305. In embodiments, if a center pole is a standard size where there does not need adjustment, the adjustment flanges or assemblies 345 and 346 may rest in recesses on the opposite horizontal section of the automation attachment or on top of the ridges 361 of the opposing horizontal section. In embodiments, for example, in FIG. 3C, adjustment flanges 345 and 346 are attached to the left horizontal section 335 and if no adjustment is needed, fit into the recesses or a ledge of the top section 341 or middle section 342 of the right horizontal section 336 of the automation attachment 300. If a smaller diameter center support pole 305 is utilized, then the adjustment flanges 345 346 may be utilized to tighten a connection by making a diameter of an automation attachment smaller. In embodiments, one adjustment flange (e.g., adjustment flange 345) may have an opening 348 and/or the other adjustment flange 346 may have a knob or tab 347. In embodiments, one of the adjustment flanges (e.g., 345) may be moved towards the other adjustment flanges (e.g., 346) or vice versa and the one adjustment flange knob or tab 347 may be inserted or placed into the opening or channel 348 to provide a smaller, tighter and/or more snug opening diameter to connect or couple to center support poles 307 that have a smaller diameter. This feature allows the automation attachment to handle many different pole diameters and be adjustable for different umbrella pole brand manufacturers. This is a significant advantage because of a capability of handling a number of different manufacturers existing manual umbrellas.

In embodiments, interior surfaces of the top sections 341 and/or the bottom sections 343 may comprise rubber or foam cushions to prevent damage when interior portions of the automation attachment 300 are contacting the center support pole 305. In addition, these cushions may be slightly tacky or have a grip that provides a slight attachment to the center support pole 305 of the existing umbrella. In embodiments, the locking mechanism or assembly may be at a top of an automation assembly (e.g., locking mechanism includes top portion 341, an adjustment flange 345 and an adjustment flange 346) or a bottom of an adjustment assembly (e.g., bottom portion 343, adjustment flange 345 and adjustment flange 346). In embodiments, the adjustment flanges 345 or 346 may wrap around a bottom portion or section 343 of the right adjustment assembly 336. In embodiments, the adjustment flanges 345 or 346 that are part of a top locking assembly may wrap around a top portion or section 341 of the right adjustment assembly 336. In embodiments, the adjustment flanges or locking flanges 345 and/or 346 may also wrap around an existing center support pole 307 or parasol pole 307.

FIG. 3D illustrates additional locking systems according to embodiments. These additional locking systems may be located on a top section of the automation attachment and a bottom section of the automation attachment. In the latch lock system illustrated in FIG. 3D, the adjustment flange or locking flange 345 may wrap around one side of an existing parasol pole 307 and an adjustment flange or locking flange may wrap or lock around another side of an existing parasol pole 307. In embodiments, a left latch lock 371 may be positioned on or attached to an adjustment flange 345, a right latch lock 373 may be positioned on or attached to an adjustment flange 346 and a latch ring 372 may couple or connect to an inside portion of the left latch lock 371 and an inside portion of the right latch lock 373.

In the belt lock system illustrated in FIG. 3D, the adjustment flange or locking flange 345 has a belt 375 connected to an outer surface and the adjustment flange or locking flange 346 has a belt 375 connected to an outer surface. In embodiments, a belt fastener 376 may tighten the belt 375 to lock a left adjustment flange or locking flange 345 to a right adjustment flange or locking flange 346. In embodiments, the belt lock system allows additional adjustments to how tight the adjustment flanges 345 or 346 are attached to the existing parasol pole 307.

In the bolt latch system illustrated in FIG. 3D, a left adjustment flange or locking flange 345 has an opening 376 and a right adjustment flange or locking flange 346 has an opening 379. In embodiments, a bolt 377 may be inserted through the opening 376 to the opening 379. In embodiments, a nut 379 may be fastened to a bolt to prevent the bolt 377 from moving. In embodiments, this tightens the left adjustment flange or locking flange 345 to the right adjustment flange or locking flange 346 and also to existing parasol pole.

FIG. 3E illustrates an additional locking system according to embodiments. The automation attachment may include a top locking attachment 391 which may also be referred to as a top cap, a bottom locking attachment 398 which may also be referred to as a bottom cap, and an automation attachment body 397. In embodiments, a top locking attachment 391 or top cap may include a plurality of recessed channels 393 on an interior surface of the top locking attachment or top cap 391. In embodiments, the automation attachment body 397 may comprise a collet body 394 and one or more vertical tabs or collet arms 392. In embodiments, the automation attachment body 397 may further comprise one or more tapered ridges or steps 399. In embodiments, the plurality of connecting tapered ridges or steps 399 may screw onto and/or into the recessed channels 393 of the top locking attachment or top cap 391 in order to form a seal in between the top cap 391 and the automation attachment body, which may be a waterproof seal. In embodiments, when the top locking attachment or top cap 391 is twisted onto the automation attachment 397, the vertical tabs or collet arms 392 may be pressed inward by the collet base 394 and thus be pressed against the parasol pole 390 in order to press the entire automation attachment against the parasol pole 397. In embodiments, the action of twisting the top cap 391 forces the collet base 394 inward along with the collet arms 392 to put a pressure against the parasol pole 395 to hold the top portion of the automation attachment against the parasol pole. In embodiments, the collet arms 392 are made of a rubber material (which may be a stiff rubber material) that can flex just enough to tighten against the parasol pole. In embodiments, a foam material may be placed on an inside surface of the collet arms 392 in order minimize the rubbing of the collet arms 392 against the parasol pole 390. In embodiments, an interior surface of the vertical tabs or collet amrs 392 may have a material such as rubber or a hard foam which also provides a good contact surface to keep the automation attachment (the body, the top locking attachment and the bottom locking attachment) from moving against and/or up and down the parasol pole 390. The twisting of the top cap 391 is shown by reference numbers 395 and/or 396. In embodiments, the bottom locking attachment or bottom cap 398 may recessed channels 393 and a bottom section or part of the automation body 397 may have tapered steps or ridges 399, a collet body 394 and a plurality of vertical tabs or collet arms 392. In embodiments, the bottom locking attachment or bottom cap 398 may twist or screw onto the automation attachment body 397 as was discussed above with respect to the top locking attachment or top cap 391. The plurality of tabs or collet arms 392 and the collet body 394 on the bottom section of the automation attachment body 397 may also be pressed against the parasol pole in a manner as is discussed above. This is a significant advantage over prior art connecting or locking systems in that there are very few mechanical parts in addition to having few parts that are external to the top cap 391, the automation attachment body 397 and the bottom cap 398. No screws or fasteners are needed in order to hold the automation attachment against the parasol pole 390 and simply unscrewing the top cap 391 and/or the bottom cap allows the automation attachment to be disengaged from the parasol pole.

In embodiments, an automation attachment 210 may be utilized to automate the opening and/or closing of the existing umbrella, parasol or shading system 200. In embodiments, the automatic operation is accomplished through a button or through bidirectional communications with a mobile computing device or other computing devices, as is discussed below. In some embodiments, the automation attachment 210 may replace the hand crank system in terms of using the hand crank (which is attached to a rope or cable 233) to open or close the existing umbrella. In embodiments, the automation attachment 210 may connect or couple with an existing pulley system and/or rope in order to open and/or close (deploy or retract) the existing umbrella. In embodiments, the automation attachment 210 may include a new pulley system that is connected to a motor assembly (e.g., a motor & pulley assembly 225) that automates an opening and closing of the prior manual umbrella, parasol or shading system (for example, an umbrella or parasol that just utilized a rope connected to an arm collar assembly 248). In alternative embodiments, the automation attachment 210 may attach or connect an existing pulley support assembly in order to lift the arm hub collar assembly 248, which lifts the one or more arm support assemblies 250, which in turn expands the one or more arms 255. This is an advantage over prior umbrella systems because now existing umbrellas may be automated without having to purchase an entire new umbrella. It also allows individuals or operators to open or close an umbrella without having to use arms or hands in order to manually operate the opening or closing of the umbrella or parasol.

In embodiments where a new pulley support assembly may be utilized, a new pulley support assembly 225 may be located within an automation attachment 210. In embodiments, the new pulley support assembly 225 may connect to or be attached to a rope or cable 233 (where the rope or cable 233 is attached or connected to the arm collar assembly 248 to lift the arm collar assembly). In embodiments, the lifting of the arm collar assembly 248 may deploy the arms support assemblies 250 and/or the arms 255 (or frame) of the umbrella, parasol or shading system 200.

In embodiments, the new pulley support assembly 225 may also be utilized with existing pulley and rope systems. In embodiments, prior existing pulley and rope systems included 1) a rope and pulley system located in an interior of an upper section of a center support assembly 207 and 2) an additional group of pulleys located separate and apart from the arm collar assembly 248, where the additional group of pulleys provided additional support or leverage to allow lifting of the arm collar assembly 248 (and thus deployment of the arm support assemblies 250 and/or arms 255). In embodiments, where an existing rope and pulley assembly is positioned or located inside a center support assembly 207, the existing rope or cable 233 may be attached to the one or more pulleys in a motor or pulley assembly 225 of an automation attachment 210. In embodiments, the other end of the rope may travel up an interior or inside of the center support assembly 207 to one or more existing pulley assemblies within an interior of the center support assembly 207 of the umbrella and then be connected or attached to the arm collar assembly 248 to lift the arm collar assembly 248 to open and close the umbrella or parasol 200. In this illustrative embodiment, for example, a rope may travel up one side of an interior of a center support assembly through one or more pulley assemblies and then travel down another side of a center support assembly and be attached to the arm collar assembly. In this illustrative embodiment, the new pulley and motor assembly 225 (because it is automatic and/or motorized) may then allow automatic opening or closing of the umbrella, parasol or shading system 200.

Similarly, a new pulley assembly 225 may be connected to an existing rope and/or pulley system that is attached to an outside surface of an existing umbrella or parasol 200. In embodiments, for example, one or more existing pulley assemblies may be attached to an outside surface of an existing umbrella (e.g., a center support assembly) and a rope may travel around the one or more existing pulley assemblies to be attached to the arm collar assembly 248. In embodiments, the rope may run up an outside surface of until it reaches a pulley assembly and travel around the pulley assembly back down to the arm collar assembly 248. In embodiments, the rope may travel a similar path to the rope or cable 233 illustrated in FIG. 2. When the rope is pulled, the rope lifts the arm collar assembly 248. In this embodiment, the new pulley assembly 225 (because it is motorized) may cause the rope to be automatically pulled (utilizing the motor) and thus lift the arm collar assembly 248 automatically (after it travels through the one or more existing pulley assemblies).

Depending on a length or height of an umbrella, parasol or shading system, additional new pulley support assemblies or support assemblies may be utilized with the automation attachment 210 (especially in situations where there are no pulley assemblies on the existing parasol or a limited number of pulley support assemblies in the existing parasol). One additional pulley support assembly may be referred to as an upper pulley support assembly 270 and another may be referred to as a middle pulley support assembly 247. As discussed, certain configurations may use both the upper pulley support assembly 270 and the middle pulley support assembly 247. In embodiments, alternative configurations may utilize only the upper pulley support assembly 270 to provide additional leverage in lifting the arm collar assembly. Both new additional pulley assemblies 247 and/or 270 may not be utilized in all configurations of umbrellas, parasols and/or shading systems.

In embodiments, for example, an upper pulley support assembly 247 may be utilized along with the automation attachment's 210 motor and pulley assembly 225. In embodiments, the upper pulley support assembly 247 may be a separate physical structure and/or housing. In embodiments, the upper pulley support assembly 247 may have an opening so that the upper pulley support assembly 247 may be positioned around the center support pole 207 (e.g., or wrapped around the center support pole). In alternative embodiments, the upper pulley support assembly 247 may not wrap around the entire center support pole or parasol pole 207 but may be attached and cover greater than 50% of the circumference of the parasol pole.

In embodiments, for example, one end of a rope and/or cable 233 may be attached or coupled to a motor shaft and/or gearing assembly and/or pulley in the automation attachment's motor and pulley assembly 225. In this illustrative embodiment, the rope and/or cable 233 may travel through one or more pulley assemblies (e.g., including, for example, the pulleys in the automation attachment 210, and/or the pulleys in the the upper pulley support assembly 270) and be attached, coupled or connected to the arm collar assembly 248 to lift the arm collar assembly 248 (which results in the expansion or retraction of the one or more arms 250 or a frame of the umbrella, parasol or shading system 200. In embodiments, the rope and/or cable 233 may also travel or be attached to a middle pulley support assembly 247 which may move upward (when pulled by the rope or cable 233), which in turn causes the arm collar assembly 248 to move upward and expand and/or open the umbrella, parasol or shading system 200 as has been discussed previously. In embodiments, the middle pulley support assembly 247 may include a rope termination or connection assembly 252 which allows the rope to be coupled, connected or attached to the middle pulley support assembly 247 (which allows movement in the middle pulley support assembly 247 so it can move upward and push the arm collar assembly 248). In embodiments, the middle support assembly 247 may provide additional pull or leverage in moving the arm collar assembly 248 in an upward direction to open the umbrella or parasol.

In embodiments, the middle pulley support assembly 247 may be a separate physical structure from the automation attachment 210. In embodiments, the middle pulley support 247 assembly may comprise a housing, where the housing is made or manufactured utilizing additive manufacturing techniques. In embodiments, the middle pulley support assembly 247 may comprise one or more pulleys or wheels, which the rope or cable 233 travels through in order to provide more stability to the rope or cable 233 and to keep the rope or cable from fraying at an end or being structurally compromised. In embodiments, the middle pulley support assembly 247 in a second physical housing may comprise one spool or one side, where the rope or cable 233 may pass through or travel past the one spool on the way up to the upper pulley support assembly 270. In embodiments, an umbrella, parasol or shading system 200 with an automation attachment 210 does not need to include both of the pulley assemblies and may only utilize one of the pulley support assemblies. In embodiments, the middle pulley support assembly 247 may wrap around or be positioned around an entire circumference or an outer surface of the center support assembly or parasol pole 207. In alternative embodiments, the middle pulley support assembly 247 may wrap around or be positioned around 50% percent or more of the entire circumference of the center support assembly or parasol pole 207.

In embodiments, as discussed above, an umbrella, parasol or shading system 200 with an automation attachment 210 may comprise an upper pulley support assembly 270. In embodiments, an upper pulley support assembly 270 may comprise a connector 271, a physical housing 236, and two or more spools 234 and 235. In embodiments, the upper pulley support assembly 270 may be located at a height above arm collar assembly 248, which may provide additional leverage in lifting an arm collar assembly 248. In embodiments, a rope or cable 233 may exit out of the automation attachment 210 on a top side of the automation attachment and travel upward to the upper pulley support assembly 270. In some embodiments, the rope or cable 233 may or may not pass through a middle pulley support assembly 247 (especially in embodiments where there is no middle pulley support assembly 247). In embodiments, the rope or cable 233 may travel around a first spool 234 (which is on one side of the upper pulley support assembly 270) and over to a second spool 235 (which is on another and potentially opposite side of the upper pulley support assembly 270) and then down to the arm collar assembly 248. In embodiments, the physical housing 236 of the upper pulley support assembly 270 may be manufactured utilizing 3D printing techniques or additive manufacturing techniques. In embodiments, the pulley support assembly 270 allows additional force and/or leverage to be used in pulling up the arm collar assembly 248.

FIG. 2B illustrates a block diagram of a motor and pulley assembly in an automation attachment according to embodiments. In embodiments, the motor and pulley assembly 225 may comprise one or motors 261, one or more pulleys or spools 262, and/or one or more gearing assemblies 263. In embodiments, a rope or cable 233 may be attached to or travel along the one or more spools 262. In embodiments, a rope or cable 233 may be attached, coupled or connected to one or more gearing assemblies 263 and/or shafts of gearing assemblies. In embodiments, the one or more motors 261 may be activated or turned on which may cause a motor shaft to rotate in a clockwise or counterclockwise fashion which in turn may rotate one or more gearing assemblies 263. In embodiments, rotation of the one or more gearing assemblies 263 may cause rotation of one or more pulleys or spools 262, which may be coupled and/or connected to the one or more gearing assemblies 263. In embodiments, the rotation of the one or more pulleys or spools 262 may cause a rope or cable 233 (which is attached thereto and/or runs in a channel of a pulley) to move (or wind or unwind) and/or to pull in an upward or a downward direction. Because an opposite end of a rope or cable 233 may be attached, coupled or connected to an arm collar assembly 248, the rotation of the shaft 264, gearing assemblies 263 and/or spools 262 may result in the arms support assemblies 250 and/or the arms 255 (or the frame of the umbrella 200) to expand or open (or retract or close). In embodiments, one or more gearing assemblies 263 may not be utilized and a shaft 264 of the one or more motors 261 may be directly connected or coupled to the one or more pulleys or spools 262 and may cause rotation of the one or more pulleys or spools 262.

In embodiments, a portion of the motor and pulley assembly 225 may be located inside a center support assembly 207 (e.g., within a tubular structure). In embodiments, for example, a portion of a right angle gearbox (e.g., a miter or bevel gear) and a shaft (which is attached to the pulley) may be located inside a center support assembly 207. In embodiments, the motor and pulley assembly 225 may be encompassed and/or positioned within the automation attachment 210 (e.g., a housing in the automation attachment). In embodiments, for example, a right angle gearbox (e.g., a miter or bevel gear) and a shaft (which is attached to a pulley) may be located physically inside an automation attachment 210. In illustrative embodiments, a motor and pulley assembly 225 may comprise a motor 261, one or more pulley assemblies or spools 262, and one or more gearing assemblies 263 (e.g., a planetary gearbox and a miter or bevel gear). In this illustrative embodiment, a motor 261 may be turned on and/or activated and a motor shaft may be connected to a planetary gearbox. In embodiments, rotation of the motor shaft causes a planetary gearbox to rotate in a clockwise or counterclockwise direction about a vertical axis. In this illustrative embodiment, a planetary gearbox may be connected or coupled to a miter or beveled gear (e.g., a right angle gearbox) to change the rotation axis. In other words, the gears on the planetary gearbox may be connected to the gears to miter or beveled gear assembly which causes the miter or beveled gear assembly to rotate in a clockwise or counterclockwise about a horizontal axis. The miter or beveled gear assembly (e.g., a right angle gearbox assembly) may be connected a shaft which is a pulley assembly (or part of the pulley assembly) 262 and rotation of the miter or beveled gear assembly causes the shaft/pulley assembly 262 to rotate. In embodiments, rotation of the shaft and thus spools of pulley assemblies 262 may cause a rope or cable 233 to wind or unwind (e.g., move), which after traveling through one or more other pulley assemblies, to pull on an arm collar assemblies 248, which results in opening or closing (e.g., expanding or retracting) the umbrella, parasol or shading system 200 (e.g., the arm support assemblies and/or arms).

A significant advantage over prior art systems is the automation attachment's size and/or portability. In embodiments, the automation attachment may comprise a single piece when a top cap and a bottom cap are connected to automation attachment body. The automation attachment also is small and easy to install without putting undue weight on the parasol pole. The automation attachment 210 also includes a significant amount of functionality within a small footprint and does not interfere with operation of the parasol because the automation attachment is installed underneath the umbrella frame or a hub for expanding the parasol/umbrella. In embodiments, the automation attachment 210 may weigh between 3 to 5 pounds. In embodiments, the automation attachment 210 may weigh between 3 to 10 pounds. In embodiments, the automation attachment 210 may be between 20 to 24 inches long. In embodiments, the automation attachment 210 may bet between 18 to 36 inches long. In embodiments, the automation attachment 210 may have a width of between 4.5 to 5.5 inches. In embodiments, the automation attachment 210 may have a width between 3.5 to 6.5 inches. In embodiments, the automation attachment 210 may be tapered so that at the top of the automation attachment and a bottom of the automation attachment 210 have a width of between 1.5 to 2.5 inches. In embodiments, a hole or opening in the center of the automation attachment may have a diameter of 1 and ⅝ inches. In embodiments, a hole or opening in the center of the automation attachment 210 may have a diameter between 1.3 and 2.3 inches in order for the automation attachment to be placed or positioned around the parasol pole. Even with this small footprint, and small dimensions, the automation attachment 210 may include or comprise one or more motor and pulley assemblies to automate opening and closing of the existing non-automated parasol, one or more speaker assemblies, one or more processors, memory devices and/or computer-readable instructions stored on the one or more memory devices for controlling operation of the automation attachment 210, one or more wireless communication transceivers (e.g., BLE, BT (or other PAN transceivers), WiFi (or wireless LAN transceivers) and/or cellular transceivers), one or more microphones, and/or voice recognition software (e.g., computer-readable instructions) or an integrated circuit for performing voice recognition based on voice commands issued by a user or operator. Within this small space or footprint, the automation attachment 210 may also include one or more sensor assemblies for measuring environmental conditions around the non-automated umbrella and/or for generating geographical or directional measurements. In addition, the automation attachment may also include one or more camera assemblies for capturing images of the area around the previously non-automated umbrella. In addition, within this small and compact footprint, a mobile computing or communication device may also communicate with the automation attachment and communicate commands to the automation attachment, while at the same time receiving measurements and/or parameters back from the automation attachment including images, sensor measurements, parameters with respect to operation of the automation attachment (e.g., how well a motor is running, which of the one or more transceivers is being utilized the most). In other words, the automation attachment provides the additional advantage of enabling and/or allowing bidirectional communications with a mobile computing device as well as other computing devices while at the same time automating operations of the parasol or umbrella.

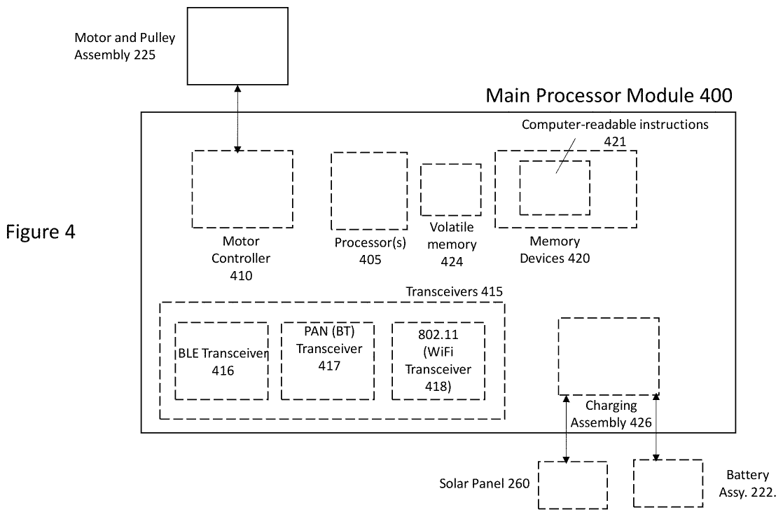

FIG. 4 illustrates a main processor module according to embodiments. In embodiments, the automation attachment 210 of the umbrella 200 may comprise a main processor module 220. In embodiments, the main processor module 220 may be one or more printed circuit boards or a series of circuit boards, where the boards have integrated circuits and/or processors mounted thereon. In embodiments, some features or functions may be implemented in hardware, software and/or a combination of both. In embodiments, the main processor module 220 may comprise a motor controller or processor 410 that communicates commands or signals to the motor or pulley assembly 225 to cause the motor to activate, turn on or off, and/or rotate. In some embodiments, the motor controller or processor 410 may be located in the motor and pulley assembly 225. In this case, one or more processors of the main processor module 220 may communicate with the motor controller or processor 410 on the motor and pulley assembly 225.

In embodiments, the main processor module 220 may comprise one or more processors 405. In embodiments, these processors 405 may be microcontroller, processors, Libre processors, systems on a chip, or other processors or controllers. In embodiments, the one or more processors 405 may be part of a single board computer, such as a Rasperry Pi computer. In embodiments, the main processor module 220 may comprise non-volatile or solid state memory devices 420, which may store computer-readable instructions 421. In embodiments, the computer-readable instructions 421 may be retrieved from the memory devices 420 and be brought into volatile memory 424 for execution by the one or more processors 405 in order to perform certain functions for the automation attachment 200.

In embodiments, the main processor module 220 may comprise one or more wireless communication transceivers. In embodiments, the main processor module 220 may comprise one or more PAN transceivers 415. In embodiments, the one or more PAN transceivers 415 may include one or more Bluetooth Low Energy (BLE) transceivers 416, one or more Bluetooth transceivers 417, one or more Z-Wave and/or one or more Zigbee wireless transceivers. In embodiments, because the automation attachment 210 may be solar powered or in some cases may be powered by a removable battery, power utilization may need to be efficient. Thus, components having lower power utilization may be preferred. In embodiments, Bluetooth Low Energy (BLE) transceivers 416 may be utilized because of the low use of power by these devices and thus the less drain on the power sources in the automation attachment. In embodiments, the one or more BLE transceivers 416 may be utilized for communications with one or more external devices (e.g., such as a mobile computing device 270 (e.g., a tablet, a smartphone, a mobile phone, a laptop) at a lower power that does not drain or reduce the power of the automation attachment 210. In addition, the BLE transceivers 416 may be utilized to communicate with other assemblies, components or devices within the automation attachment. In embodiments, the one or more BLE transceivers 416 may communicate with the one or more lighting assemblies 221. In embodiments, for example, the one or more BLE transceivers 416 may communicate with the one or more processors 405. In embodiments, the one or more BLE transceivers 416 may communicate with one or more motor controllers 410. In embodiments, the one or more BLE transceivers 416 may be utilized for communication with the one or more environmental sensor assemblies 227. In embodiments, the one or more BLE transceivers 416 may be utilized to communicate with one or more charging assemblies (not shown). As mentioned, by using the BLE communication protocol with the different assemblies, components, or external devices, power may be conserved in the automation attachment 210 which allows the automation attachment 210 to be powered under solar power. Other low energy wireless communication transceivers may also be utilized.

In embodiments, the one or more PAN (e.g., Bluetooth) transceivers 417 may be utilized to receive audio communications (e.g., digital music files and/or sound files) which may then be communicated to the one or more integrated speakers 226 of the automated attachment 210. In embodiments, if one or more cameras are added to the automation attachment, the Bluetooth transceivers 417 may be utilized to bi-directionally communicate commands or instructions to the camera and captured sound or video or images to other components or assemblies or to external computing devices (e.g., such as servers and/or mobile computing devices 272). In embodiments, if microphones are utilized to captured audio from an environment around the umbrella or from a user or operator, then the one or more Bluetooth transceivers 417 may be utilized to communicate commands to the microphones 285 and to transmit captured audio files that were captured by the one or more microphones 285.

In embodiments, the automation attachment 210 may comprise one or more LAN or WAN wireless communication transceivers 418 (e.g., 802.11 wireless transceivers or WiFi transceivers). In embodiments, the one or more LAN or WiFi transceivers 418 may be utilized to receive audio communications (e.g., digital music files and sound files) which may then be communicated to the one or more integrated speakers 226 of the automated attachment 210. In embodiments, if one or more cameras are added to the automation attachment, the LAN or WiFi transceivers 418 may be utilized to bi-directionally communicate commands or instructions to the camera and captured sound or video or images to other components or assemblies or to external computing devices (e.g., such as servers and/or mobile computing devices 272). In embodiments, if one or more microphones 285 are utilized to capture audio (e.g., spoken voices) from an environment around the umbrella or from a user or operator, then the one or more LAN or WiFi transceivers 418 may be utilized to communicate commands to the microphones 285 and to transmit captured audio files that were captured by the one or more microphones 285. In embodiments, the automation attachment 210 and/or the main processor module 220 may comprise one or more wireless cellular transceivers (not shown).

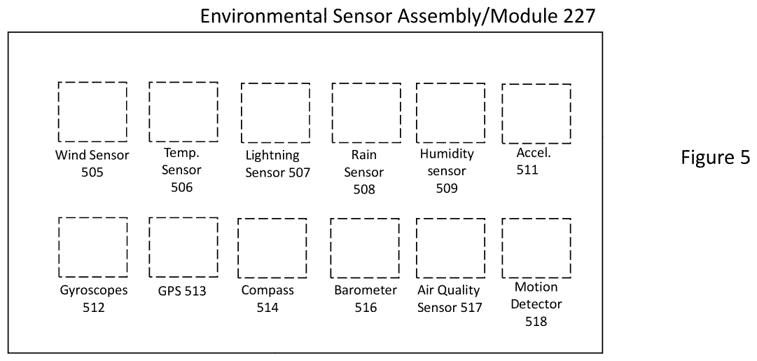

In embodiments, the automation attachment 210 may comprise one or more environmental sensor assemblies 227. FIG. 5 illustrates an environmental sensor assembly according to embodiments. In embodiments, the one or more sensor assemblies 227 may be one or more wind sensors 505. In embodiments, the one or more environmental sensor assemblies 227 may be temperature sensors 506, lightning sensors 507, rain or moisture sensors 508 and/or humidity sensors 509. In embodiments, the one or more sensor assemblies 227 may be directional sensors such as one or more accelerometers 511, one or more gyroscopes 512, one or more GPS or GLONASS transceivers 513, one or more digital compasses 514, one or more motion detectors or motion sensors 518 (e.g., also including LOS sensors, sonic sensors, LIDAR sensors, and/or one or more digital barometers 516). In embodiments, the one or more sensor assemblies 227 may comprise air quality sensors 517 (e.g., carbon monoxide sensors, carbon dioxide sensors, radiation sensors, UV radiation sensors (e.g., not light sensors), and/or smoke sensors).

In embodiments, the main processor module 220 may include one or more processors 405, one or more memory modules or devices 420 and/or computer-readable instructions 421 stored in the one or more memory modules or devices 420. In embodiments, the computer-readable instructions 421 may be executable by the one or more processors 405 in the main processor module 220 to communicate with one or more sensors (e.g., any of the sensors listed above) in the sensor assemblies or modules 227. In embodiments, the communication may be to activate one or more sensors of the one or more environmental sensor assemblies 227. In embodiments, the communication may be to receive readings, measurements or status indicators from one or more sensors of the one or more sensor assemblies 227. In embodiments, the readings, measurements, and/or status parameters may be raw measurements and/or in other embodiments, the readings, measurements or status parameters may be processed or refined measurements. In embodiments, other communication buses, protocols and/or transceivers may be utilized (e.g., such as using an I2C bus and/or CAN bus) to communicate with one or more sensors of the one or more environmental sensor assemblies 227. In embodiments, the one or more processors 405 of the main processor module 220 may communicate with the sensor assemblies or modules 227 utilizing a BLE transceiver 216. In embodiments, the sensor assemblies or modules 227 may individually include a BLE wireless communication transceiver.

In embodiments, computer-readable instructions 421 executable by the one or more processors 405 of the main processor module 220 may directly activate and/or request measurements, reading values and/or status measurements from the one or more sensors and may receive measurements, reading values and/or status measurements from one or more sensors in the one or more sensor assemblies 227. In this case, a BLE wireless transceiver may not need to be utilized because there is a communication link between one or more processors 405 and/or one or more sensors In embodiments, the one or more sensors assemblies 227 may be made utilizing a 3D printer or by additive manufacturing techniques. In embodiments, the one or more sensor assemblies 227 may be modular, detachable and/or removable from a core housing of an automation attachment 210. This provides an advantage of being able to remove and replace malfunctioning sensors, to add additional or new sensors, and/or to upgrade to new or different sensors in the one or more sensor assemblies 227 in the automation attachment 210

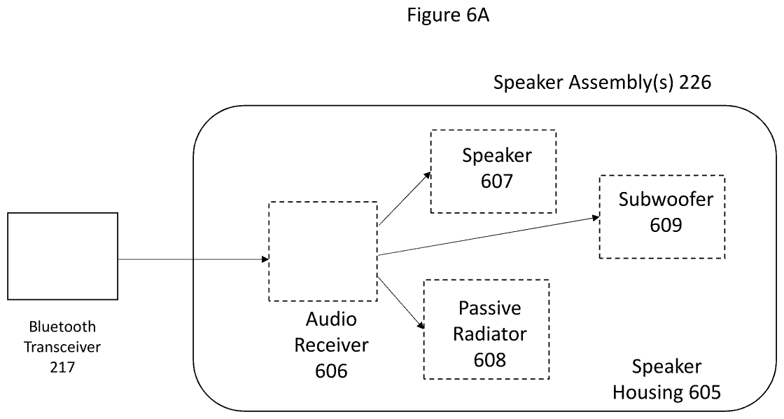

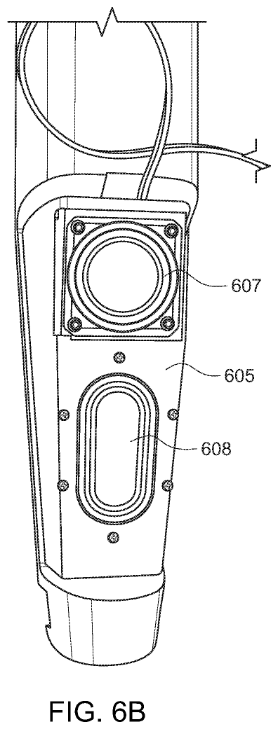

In embodiments, the automation attachment 210 may comprise one or more speaker assemblies 226. In embodiments, the automation attachment 210 may comprise two speaker assemblies 226 or four speaker assemblies 226. FIG. 6A illustrates a block diagram of a speaker assembly according to embodiments. In embodiments, each of the one or more speaker assemblies 226 may comprise a housing 605, a speaker or sound reproduction device 607, and/or a passive radiator 608. In embodiments, each of the one or more speaker assemblies 226 may further comprise an audio receiver 606 or, alternatively, an audio receiver 606 may be shared and/or utilized by multiple speaker assemblies 226. In embodiments, audio (e.g., music files and/or sound files) may be communicated by the one or more PAN (e.g., Bluetooth) transceivers on the main processor module 220 to the audio transceiver(s) 606 and then reproduced on the speaker(s) 607 and/or the passive radiator(s) 608. In embodiments, the one or more speaker assemblies 226 (and/or the speaker housing 605) may be made utilizing a 3D printer or by additive manufacturing techniques. In embodiments, the one or more speaker assemblies 226 (and/or the speaker housing 605) may be modular, detachable and/or removable from a core housing or section of an automation attachment 210. FIG. 6B illustrates a speaker assembly including a speaker and a passive radiator in a section of an automation attachment 210 according to embodiments. This detachability provides an advantage of being able to remove and replace audio components or assemblies (e.g., speaker(s), audio transceiver(s) and/or passive radiator(s)) in the one or more speaker assemblies 226. In embodiments, the one or more speaker assemblies 226 may further comprise one or more subwoofer 609.

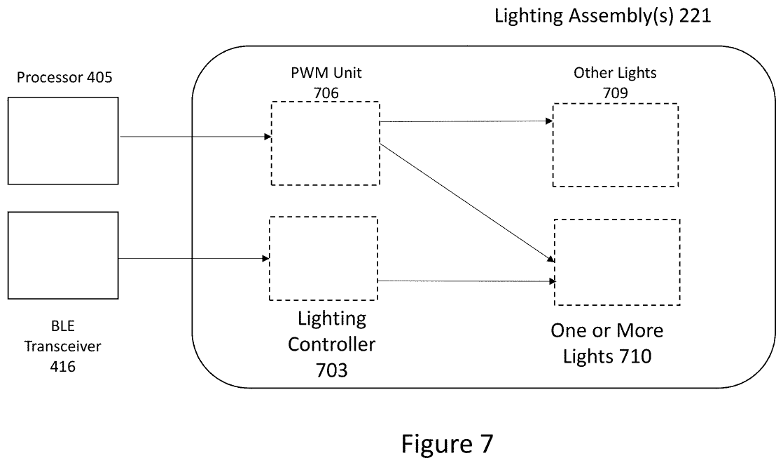

In embodiments, the automation attachment 210 may comprise one or more lighting assemblies 221. In embodiments, the one or more lighting assemblies 221 may comprise one or more LED lights 710. FIG. 7 illustrates a block diagram of one or more lighting assemblies according to embodiments. In embodiments, the one or more LED lights 710 may project light in an upward direction, a downward direction or at an angle approximately 90 degrees from a vertical axis (e.g., sideways). In embodiments, the one or more LED lights 710 may comprise a single light or may comprise a strip of lights. In embodiments, the one or more lighting assemblies 221 may comprise a lighting controller 703 to receive signals or commands from a wired or wireless communication transceiver to activate or turn off the lights and/or to change a brightness or intensity of the lights. In some embodiments, a controller may not be utilized. In embodiments, a BLE transceiver 416 on a main processor module 220 may communicate a signal or command to the one or more lighting assemblies 221 to turn on or off the lights or change the brightness of the lights. In embodiments, the signal or command may be a high frequency signal such as a pulse width modulation signal to control a turning on, a turning off and/or an adjustment of a brightness of the one or more lights in the one or more lighting assemblies. In some embodiments, the signal communicated from the BLE transceiver 416 may pass through a lighting controller 703 before being communicated to the one or more lights in the one or more lighting assemblies 221. In an alternate embodiments, the one or more lighting assemblies 221 may comprise a PWM control unit 706. In embodiments, computer-readable instructions executable by one or more processors 205 in the main processor module 220 may communicate with the PWM control unit 706 utilizing an I2C and/or SPI protocol. In embodiments, this provides an advantage over the BLE transceiver communicating with the one or more lighting assemblies because the PWM control unit 606 may communicate multiple PWM control signals and thus independently control multiple lights 709 and/or 710 in the one or more lighting assemblies 221. In embodiments, this may be very useful when a color lighting system (e.g., RGBW color lighting system) in the automation attachment 210. In contrast, if the BLE transceiver is utilized, there are a limited amount of control signals that may be communicated to the one or more lighting assemblies 221 (because the main processor module 220 has a limited amount of control signals that may be generated). In embodiments, the one or more lighting assemblies 221 (and/or a lighting assembly housing) may be made utilizing a 3D printer or by additive manufacturing techniques. In embodiments, the one or more lighting assemblies 221 (and/or the lighting assembly housing) may be modular, detachable and/or removable from a core housing of an automation attachment. This provides an advantage of being able to remove and replace components or assemblies (e.g., lighting assemblies or lights or PWM control units) in the one or more lighting assemblies 221. In embodiments, a lighting strip may also be provided that may be attached to one or more of the arms or blades 255 to provide light for a surrounding area. In embodiments, the lighting strip may be powered by one or more batteries provided within the lighting strip. In embodiments, a cable may run from a lighting assembly to the lighting strip alongside the center support assembly 207 or within or inside the center support assembly 207.

In embodiments, the automation attachment 210 may comprise a power subassembly 280. In embodiments, a power subassembly 280 may comprise a power plug to receive power from an external power source (e.g., a wall outlet or an outdoor outlet) and to provide power to one or more charging assemblies (not shown). In embodiments, the one or more charging assemblies may distribute power to other components in the automation attachment 210. In embodiments, the power subassembly may comprise a removable and/or detachable rechargeable battery 223 and/or one or more charging assemblies to distribute power to other components and/or assemblies in the automation attachment 210. In embodiments, a removable and/or detachable rechargeable battery 223 may be plugged into a separate and/or independent docking station in order to be charged with suitable power for the automation attachment 210 of the umbrella and/or parasol. For example, a user, operator and/or owner of an umbrella or parasol could have multiple rechargeable batteries 223 and could charge one battery while another battery is providing power to the automation attachment 210 and/or the umbrella 220. In embodiments, one or more rechargeable batteries may be powered via one or more solar panels 260. In embodiments, the one or more solar panels 260 may be attached and/or connected to a power subassembly 280 (and/or the one or more charging assemblies and/or the one or more rechargeable batteries 223) via a cable 247. In embodiments, the one or more solar panels 260 may be attached to a frame, an arm or blade and/or fabric of an existing umbrella or parasol. In embodiments, the one or more solar panels 260 may come in a kit with the automation attachment 210 and the cable 247. In embodiments, when the cable is not in use, it may be positioned or fastened next to or on an underside a frame of the umbrella, the arm support assemblies, the arms of the parasol or umbrella.

In embodiments, the automation attachment 210 may comprise one or more microphones 285 or audio input devices. In embodiments, the one or more microphones 285 or audio input devices may be a microphone line array. In embodiments, the one or more microphones may allow the automation attachment 210 to receive voice commands and either 1) analyze the voice commands within the automation attachment 210 to generate corresponding umbrella device or assembly commands or instructions and/or 2) to communicate (e.g., transmit) the received voice commands for analyzation and interpretation by an external computing device (e.g., such as a voice recognition server), where the external computing device communicates back analyzed or interpreted umbrella device or assembly commands. In embodiments, the one or more microphones 285 may be embedded into a surface of the automation attachment 210 or may be a line array that is built into and/or connected to automation attachment 210. In embodiments, the one or more microphones 285 may be part of, built in, or integrated into the main processor module 220. In embodiments, the one or more microphones 285 may be positioned on multiple surfaces or portions of the automation attachment 210 so as to capture voice commands spoken from a number of directions. In embodiments, the voice commands received via the one or more microphones may allow a user or operator to command operation for example of different assemblies in the umbrella and specifically the automation attachment 210.

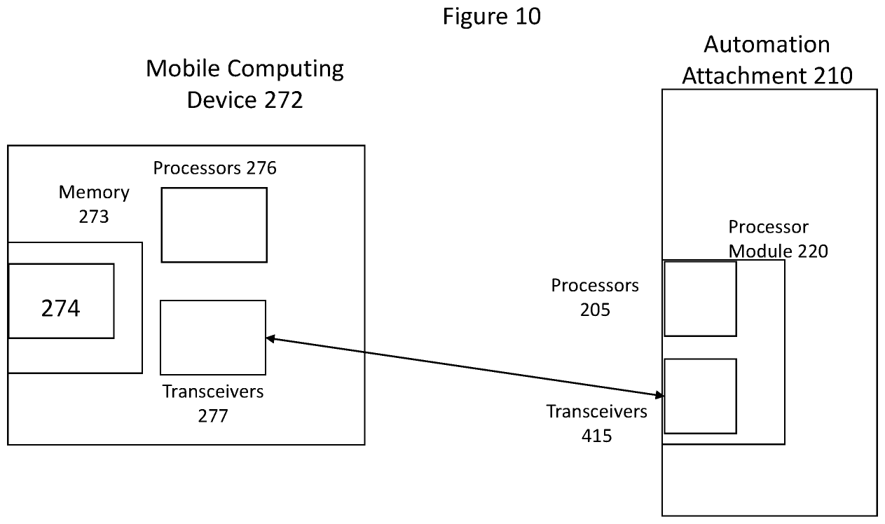

In embodiments, a mobile communication or computing device 272 may communicate with the automation attachment 210 in order to control operations of sensors, components, assemblies and/or devices, receive status parameters for components, assemblies and/or devices, and/or receive sensor measurements or parameters. FIG. 10 illustrates bidirectional communications between a mobile communication or computing device and an automation attachment according to embodiments. In embodiments, a mobile communication device 272 may be communicating bi-directionally with the automation attachment 210 of the umbrella or parasol. This is a significant improvement over communicating via a remote control device where only limited commands such as on or off may be communicated to an umbrella and there is no receiving of parameters and/or measurements back from an umbrella or parasol 200. The automation attachment described herein may be controlled by a software application running on a mobile computing device 272 and may communicate measurements, parameters, information and/or images back to the mobile communications device 272. In embodiments, for example, a mobile communication device 272 may comprise one or more processors 276, one or more memory devices 273, one or more wireless communication transceivers 277 and/or computer-readable instructions 274 stored in the one or more memory devices 273. In embodiments, the computer-readable instructions 274 stored in the one or more memory devices 273 may include automation attachment software (e.g., interface or control software). In embodiments, the computer-readable instructions 274 may be executable by the one or more processors 276 to communicate and/or interface with the automation attachment 210. In embodiments, for example, the software 274 executable by one or more processors 276 of a mobile computing device 272) may communicate commands, messages and/or instructions to an automation attachment 210 via one or more wireless communication transceivers 277 to open or close an umbrella, to turn on lighting assemblies, to engage and/or activate motors, to turn on cameras as well as other features describe herein. In embodiments, the communications may be received via one or more wireless communication transceivers 415 in the automation attachment 210. In embodiments, the software 274 in the mobile computing device 272 may receive operational parameters and/or confirmation back that the operation has been completed and the utilized components and/or assemblies (e.g., motors, pulleys) are operational) via the one or more wireless communications transceivers 277 in the mobile computing device 272. In embodiments, as another example, a mobile communication device 270 may communicate a command to activate a wind sensor (or other sensor in the automation attachment) and to capture wind sensors (or other sensor) readings or measurements. In embodiments, the automation attachment 210 may communicate and/or transmit back captured wind sensor measurements (or other sensor measurements) to the mobile communication device utilizing the one or more wireless communication transceivers 415 in the automation attachment and the one or more wireless communication transceivers 277 in the mobile computing device 272. In embodiments, the components or assemblies of the automation attachment 210 that may be bidirectionally communicated with by the mobile computing device 272 may include motor and pulley assembly, one or more environmental sensors, one or more directional sensors, one or more cameras in a camera module, one or more audio transceivers and/or speakers, one or more voice recognition engines, one or more lighting elements or lighting assemblies, one or more microphones, one or more battery assemblies, and/or one or more solar panels. In embodiments, a mobile communication or computing device 272 may utilize software installed thereon to communicate with the automation attachment 210 (e.g., SMARTSHADE SOFTWARE) and receive input via a touchscreen, a keyboard, a stylus or other user interface input components. In embodiments, a user or operator may speak audio commands into a mobile computing device 272 to control operation of the automation attachment (“Open Umbrella, Close Umbrella, Turn on Speakers, Turn on or off lights, Capture Sensor Measurements”).

In embodiments, the computer-readable instructions 277 executable by the one or more processors 276 of the mobile computing device 272 may include voice recognition software in addition to the automation attachment software. In embodiments, the voice recognition software executing on the one or more processors 276 of the mobile computing device 272 may recognize, interpret and generate umbrella or parasol-specific commands and the mobile computing device 272 may communicate the generated umbrella or parasol-specific commands to the automation attachment 210 via wireless communication transceiver 277 and wireless communication transceiver 415 to control operations of assemblies and/or components in the automation attachment (e.g., motors, sensors, lights, etc.). In embodiments, the voice commands may be communicated as audio files to the automation attachment 210, (via the wireless communication transceivers 277 and 415) and computer-readable instructions executable by one or more processors 205 in the automation attachment, which may either analyze, recognize and then generate umbrella or parasol-specific commands locally (e.g., within the automation attachment 210) or may communicate the received audio files (or text representative thereof) to a third party computing device (a voice recognition server, such as Alexa servers, located locally or remotely) for analyzation, interpretation and generation of umbrella or parasol-specific commands, which are then communicated back to the automation attachment 210 in order to have the recognized operations performed via wireless or wired communication transceiver. In embodiments, the mobile communications device 270 may be a smartphone, a tablet, a laptop computer, a network computer, a mobile phone, etc.). Although the discussions above have focused on a mobile computing device, the discussions apply to desktop computers, administrative computing devices, point-of-sale computing devices and/or home security computing devices, all of which can have automation attachment interface software installed thereon and executable by processors to interface with and/or control an automation attachment that the desktop computing device, administration computing device, POS computing device and/or home security device are communicatively coupled with (e.g., via wireless or wired communication transceivers).

In embodiments, a mobile communications device 270, a computing device at a remote location, or an existing computing device (e.g., a POS terminal at a hospitality venue) may communicate with and receive communications from a plurality of automation attachments on various umbrellas, shading devices, and/or parasols utilizing wireless or wired communication transceivers. In embodiments, for example, this means a facility or event venue with multiple manual umbrellas, may install automation attachments 210 on one or more of the umbrellas, shading devices and/or parasols and be able to control the operation of multiple parasols, umbrellas or shading devices. In embodiments, because the automation attachments 210 may be removable or detachable from the existing manual umbrellas, the automation attachments 210 may be moved from one or more umbrellas, parasols, and/or shading devices to another umbrellas, parasols, and/or shading devices. This provides an advantage and/or improvement over existing systems because there is the ability to automate a number of parasols or umbrellas and there is also the flexibility of moving the automation attachments to different umbrellas in different areas (so that a venue does not have to buy an automation attachment for every umbrella). In embodiments, the mobile computing device 272 (or computing device at a remote location or existing computing device at hospitality venue) may bidirectionally communicate with two or more automation attachments 210 via the one or more wireless communication transceivers 415 in the automation attachment 210. In embodiments, the components, assemblies or devices (e.g., environmental sensor assemblies 227; main processor module 220, motor pulley assembly 825 and/or the LED assemblies 221, and/or one or more image devices) may communicate sensor measurements and values; audio, video, images; and/or status parameters of components, assemblies or devices back to the mobile computing device 272 via the one or more wireless computing devices 415 (or computing device at a remote location or existing computing device at hospitality venue). In embodiments, the measurements and/or status parameters may be displayed within application software executing on the mobile computing device 272 (or remote computing devices) after being received via the one or more wireless communication transceivers (e.g., such as the wireless communication transceiver(s) of the mobile computing device 272). In embodiments, the operation of the multiple automation attachments on multiple umbrellas, parasols or shading devices may be controlled via fleet management software such as has been described in application Ser. No. 16/008,000, filed Jun. 13, 2018, and entitled METHOD AND SYSTEM OF FLEET MANAGEMENT OF SHADING DEVICES, which is incorporated herein by reference. In embodiments, voice control, gesture recognition and/or utilization of menu icons may be utilized to control operation of one or more multiple umbrellas through the software.

In embodiments, automation attachment may further comprise a button or control panel 290 to control operation of the automation attachment 210 (e.g., the assemblies of the automation attachment and the opening and closing of the umbrella arm support assemblies 250 (or frame) and arms). In embodiments, a button 250 may be electrically and/or communicatively coupled with the one or more processors 205 in the main processor module 220 so that specific commands may be processed and/or interpreted by the main processor module. In embodiments, computer-readable instructions 421 executable by the one or more processors may receive signals from one of the buttons or a control panel, may interpret the received signals to determine what operations may need to be performed, and then may generate commands or instructions to the designated and/or selected assemblies or components. For example, pressing of a button may result in opening and/or closing of an umbrella. In embodiments, the control panel 290 may comprise multiple selectable icons or buttons (e.g., open/close umbrella arms/turn on or off lights/turn on audio system and play music/activate sensor assemblies to capture sensor readings/turn on or off microphones to allow voice command capture/turn on or off wireless communication capabilities)

In embodiments, the upper pulley support assembly 270 and/or the middle pulley support assembly 247 may also include additional components, assemblies or devices housed therein and/or attached thereto. In embodiments, for example, the upper pulley support assembly 270 may comprise one or more lighting assemblies and the lighting assemblies may comprise one or more lights (e.g., LED lights). In embodiments, the one or more lighting assemblies may receive power via a battery in the upper support assembly 270. In embodiments, the one or more lighting assemblies in the upper pulley assembly 270 may receive power via power lines or cables that are connected to either a rechargeable battery or a charging assembly in the automation attachment 210.

In embodiments, the power lines or cables may be part of or integrated with the rope and/or cable 233 that is running or traveling through the pulleys and/or attached to the arm collar assembly 248. In these illustrative embodiments, the rope or cable 233 may transfer power via an input port or connector (e.g., USB or other power connector) or through inductive coupling where the rope or cable 233 induces a current into a coil that is resident within the upper pulley support assembly 270. For umbrellas, parasols and shading systems, this is an advantage over existing systems because the rope or cable may now serves multiple purposes of 1) providing the mechanism for lifting up an arm collar assembly and 2) for transmitting signals and/or power to different components with a parasol and/or automation attachment 210. In addition, this allows one or more components to be located in the upper pulley support assembly 270 and thus more features may be provided to the existing parasols, umbrellas or shading systems. In embodiments, for example, the upper support assembly 270 may further comprise one or more audio speakers to reproduce audio (e.g., voices and/or music). In embodiments, the one or more audio speakers may be power as discussed by the power transmitted by the rope or cable. In embodiments, the one or more audio speakers in the upper support assembly 270 may include a PAN transceiver and may receive audio signals communicated from a PAN transceiver in the main processor module 220 or alternatively, from a PAN transceiver in a mobile communications device 272 transmitting the audio signals to the umbrella, parasol or shading system 200.

In embodiments, the upper pulley support assembly 270 may further comprise one or more sensor assemblies (e.g., wind sensor, humidity sensor, temperature sensors or other sensors described above). In embodiments, the one or more sensor assemblies may be self-powered (e.g., a wind sensor may be powered by mechanical movement of components when wind is detected and captured) or may be powered from a rechargeable battery in the upper support assembly 270. In embodiment, the one or more sensors present in the upper pulley support assembly 270 may be powered via a cable from an automation attachment battery 222 or charging assembly. In embodiments, a mobile computing device 272 may communicate with an environmental sensor assembly in an upper support assembly 270 if the environmental sensor assembly has a BLE transceiver. In embodiments, a main processor module's 220 BLE transceiver 416 may communicate with a BLE transceiver in the upper pulley support assembly 270 to activate or deactivate the sensor assembly in the upper pulley support assembly 270, capture measurements and then receive sensor measurements or sensor status parameters from the sensor assembly in the upper support assembly 270. In embodiments, it may be beneficial to place sensors in the upper support assembly 270 to verify readings taken by sensors in the sensor assembly 227 of the automation attachment 210 as well to obtain readings or measurements from a different part of the environment surrounding the umbrella, shading device, or parasol.

In embodiments, the upper pulley support assembly 270 may be attached or connected via a wire or cable or rope to one or more solar panels or arrays 260. In embodiments, the solar panels or arrays 260 may provide power to the upper pulley support assembly 270 either directly or through a charging assembly or voltage regulator located in the upper pulley support assembly 270. The solar panels or arrays 260 may also provide similar power to the middle pulley support assembly 247. In embodiments, the one or more solar panels or arrays 260 may be detachable from a shading fabric, arm and/or frame and also may be plugged into and/or detachable from the upper pulley support assembly 260 or middle pulley support assembly 247.

In embodiments, the upper pulley support assembly 270 may be attached to center support assembly 207 via a fastener or connector such as a pin. In embodiments, the upper pulley support assembly 270 may have a space or hole in its center through which the center support assembly 207 may pass and there may be rubber or adhesive rings that are attached to or integrated into the upper pulley support assembly 270 and then may be pressed against the center support assembly to make sure the upper pulley support assembly 270 does not move. In embodiments, the upper pulley support assembly 270 may be two or more pieces that snap, fit or connect together. In embodiments, a coupling attachment may be placed about the center support assembly 207 and a ridge of an upper pulley support assembly 270 may be placed or inserted into the center support assembly 207. In embodiments, the couplers described previously with respect to the automation attachment 210 may be utilized with the upper pulley support assembly 270 and/or the middle pulley support assembly.

Although the preceding discussion has focused on the upper pulley support assembly 270, the middle pulley support assembly 247 may also comprise environmental sensor assemblies, lighting assemblies, rechargeable batteries and/or speaker assemblies and may be also attached to a solar panel assembly 260, as discussed above with respect to the upper pulley support assembly 270.

In embodiments, the automation attachment 210 may also come with a rope or cable 233 that not only may be utilized to attach to a shaft, travel through pulleys and/or lift (or assist in lifting) an arm collar assembly 248. In addition, the rope or cable 233 may also be utilized to communicate data, information or signals between the automation attachment 210 and other structures, components and/or assemblies in the parasol or umbrella, as well as to provide power to the other structures, components and/or assemblies in the parasol or umbrella. This is a significant improvement to existing umbrellas in that the rope or cable becomes multi-purpose and a tool in supplying power to provide additional features for the existing umbrella. In embodiments, the cable or rope 233 may provide power and/or data utilizing a USB communication protocol, an I2C communication protocol and/or a CAN communication protocol. In embodiments, 1) one or more interior lines, conductors or wires of a cable or rope 233 may be utilized for data or control signal communication and 2) one or more interior lines, conductors or wires may be utilized to providing or transferring power. In embodiments, the cable or rope 233 may need to be flexible enough to bend around pulleys and may need to be strong enough to be utilized to lift an arm collar assembly 248 while at the same time protecting the wires and/or conductors located on an interior of rope or cable 233. In embodiments, the rope or cable 233 may be fastened to or travel along a center support assembly 207 as it connects, for example, the automation attachment 210 to an upper pulley support assembly 270, a middle pulley support assembly 247, sensors or other components external to the automation attachment 210 and/or the one or more solar panel assemblies 260. In embodiments, another cable may be utilized to connect the one or more solar panels or arrays or cells 260 to a charging assembly, and/or a rechargeable battery 223 located in the automation attachment 210. In embodiments, the rope or cable 233 may be detachable at different parts or locations of the existing umbrella and/or automation attachment 210.

In embodiments, an automation kit may be supplied to a user or operator to automate an existing umbrella, parasol or shading system. In embodiments, an automation kit may comprise a multi-piece automation attachment 210, one or more rechargeable batteries 223, and/or one or more ropes and/or cable 233. In embodiments, the automation kit may comprise an upper pulley support assembly 270. In embodiments, the automation kit may comprise a middle pulley support assembly 247. In embodiments, the automation kit may further comprise one or solar cells, panels or arrays 260. In embodiments, an automation kit may comprise one or more rubber (or flexible material) adapters or couplers to attach or press next to a center support assembly 207 and hold the automation attachment 210, the upper pulley support assembly 270 and/or the middle pulley support assembly 247 against the center support assembly 207. In embodiments, the multi-piece automation attachment 210 may comprise two pieces or four pieces that are connected together (via snap connectors or fasteners) or fitted together utilizing hooks and/or recesses. In embodiments, each of the pieces (e.g., housings) of the automation attachment 210 may have modular assemblies that attach and/or detach from the housing pieces in order to allow a user or operator to upgrade, change out and/or replace existing components and/or assemblies. In embodiments, these modular assemblies may include a main processor module 220, one or more environmental sensor assemblies, one or more speaker assemblies 226, a motor pulley assemblies 225 and/or one or more battery assemblies 222.

In embodiments, the automation attachment 210 may be water proof and moisture may not penetrate an interior of the automation attachment 210. In embodiments, the automation attachment 210 may be waterproof because 1) housings of the automation attachments may be form fitted to seal any openings; 2) the rubber adapters may form a seal so an interior portion of the automation attachment (e.g., by the center support assembly 207) may be sealed from any water coming into the automation attachment; and/or 3) most if not all the components be located inside housings of the pieces of the automation attachments. In embodiments, the rope or cable 233 may be located in a center support assembly and thus emerge outside the automation attachment 210 but not compromise the waterproof seal or nature of the automation attachment. In embodiments, the rope or cable's 233 entrance into the automation attachment may be made utilized an electronic connector or port, which may be covered when not in use. Further, rubber connectors or gaskets may be utilized to seal off an entrance of the rope or cable into the automation attachment 210.

In embodiments, certain operations may cause audio to be broadcast from the one or more speaker assemblies 226. In embodiments, computer-readable instructions 241 executable by the one or more processors 205 may monitor when certain events are occurring in the automation attachment 210 and/or umbrella and may transfer or communicate pre-designated sound files to the speaker assemblies 226 for broadcast. For example, if it is detected that the pulley and motor system 225 is being utilized, an “umbrella opening” or “umbrella closing” audio file may be communicated to the speaker assemblies 226 to warn users or operators. Similarly, timers could be set so that the computer-readable instructions executable by the one or more processors transfer audio files when lights are being turned on or off or when a solar panel is being utilized.

In embodiments, an automation attachment 210 may further comprise one or more USB charging ports 295. In embodiments, the USB ports or interfaces 295 may provide power to mobile computing devices 272 or may provide a method to transfer in large files directly to the automation attachment 210 (e.g., sound files, video files, new software updates or patches). In embodiments, the USB port 295 may receive power from a charging assembly, a rechargeable battery 223 and/or a regulator on a main processor module 220. In embodiments, the main processor module 220 may have USB interfaces built in and the USB port 295 may receive power (e.g., voltage and current).

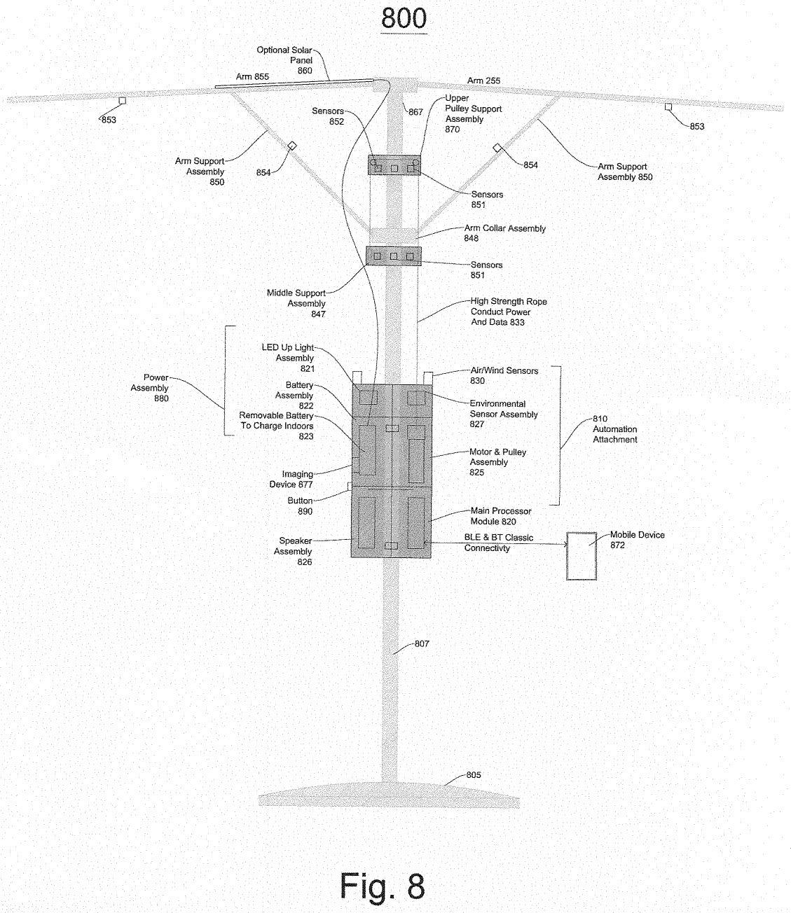

FIG. 8 illustrates an automation attachment including sensors to monitor movement of an umbrella, parasol or shading system according to embodiments. In embodiments, an umbrella, parasol or shading system may comprise a base 805, a center support assembly 807, an automation attachment 810, an arm collar assembly 848, one or more arm support assemblies 850 and/or one or more arms 855. In embodiments, as discussed above, the parasol, umbrella, or shading system may further comprise one or more middle pulley support assemblies 847, and/or one or more upper pulley support assemblies 870. In embodiments, for safety reasons, it is important to know a position of the frame or the arms of the umbrella during opening and closing. In embodiments, an automation attachment 210 may comprise one or more motion sensors 830. In embodiments, the one or more motion sensors 830 may be utilized to detect a position of the arm support assemblies 850 and/or the arms 855. Specifically, the one or more motion sensors 830 may be active sensors which may transmit infrared energy or radar waves and/or radio waves to sweep an area to detect movement of the arm support assemblies 850 and/or arms. In embodiments, the one or more motion sensors 830 may utilized a focused beam of energy that travels between an emitter (e.g., on the automation attachment and a sensor unit on the center support 807, the arm support assemblies 850 and/or the arms). In other words, the energy or wave could be transmitted to a positon which corresponds to a position where the arm support assembly 850 (and arms) is opened at 70%. In embodiments, if a sensor unit receives the light, then computer-readable instructions executable by one or more processors, this means the arm support assembly is opened at 70%. Similarly, there may be other sensor units or assemblies at other percentage open positions, including but not limited to, 100% open. In embodiments, status parameters and/or measurements of the one or more motion sensors 830 may be transmitted from the motion sensors 830 and evaluated by the computer-readable instructions executable by the one or more processors. In embodiments, computer-readable instructions executable by the one or more processors may communicate status indicators (or a representation thereof such as an audio file to one or more speaker assemblies 826) and/or an external computing device 872 to be displayed within software executing on the external computing device 872.

In embodiments, another way to determine a deployment or retraction percentage of the one or more arm support assemblies is to utilize encoders and/or limit switches on the one or more motor assemblies. In embodiments, for example, a motor assembly may comprise a motor, a motor controller, a motor shaft and/or an encoder. In embodiments, an encoder may count how many turns a motor makes. In embodiments, a first turn count may represent that arm support assemblies/arms have moved from a rest position to a 50% extended position and a second turn count may represent that arm support assemblies/arms have moved to a fully extended position (or 1005 expansion). In embodiments, another way to determine a deployment or retraction percentage is to utilize a motor and limit switches. In embodiments, for example, a motor assembly may comprise a motor, a motor controller, a motor shaft and/or one or more limit switches. In embodiments, the limit switches correspond to an end point for a motor (when it has rotated and/or moved the shaft to an end position (during deployment) or a start position (during retraction). In embodiments, if a first limit switch is reached, this corresponds to the arms or arm support assemblies being fully extended or open. In embodiments, if a second limit switch is reached, this corresponds to the arms or arm support assemblies being closed or fully retracted. In embodiments, the motor assembly may be part of the motor and pulley assembly 825. In embodiments, a motor assembly may utilize both an encoder and/or limit switches to monitor motor movement. In embodiments, computer-readable instructions executable by one or more processors of an automation attachment may be monitoring a number of turns (e.g., via an encoder) and/or whether or not a limit switch has been reached and/or activated. In embodiments, if these conditions are met, computer-readable instructions may communicate a sound file to the one or more speaker assemblies to play a message for a user or operator and/or may communicate a message (or text message) via one or more wireless communication transceivers to a mobile communication device for display to a user or operator.

In embodiments, an automation attachment 810 may further comprise air or wind sensors 830 to measure wind speed in an environment around the parasol, umbrella and/or shading system. In embodiments, the air or wind sensors 830 may be outside or attached to a top surface of an automation attachment 810 in order to measure wind speed at an elevation about a ground surface. In addition, by being placed on a top surface of an automation attachment 810, the one or more wind sensors 830 may be able to measure wind speed without having to worry about the automation attachment 810 blocking the wind. In embodiments, the one or more wind sensors 830 may transmit wind sensor measurements and/or status parameters to one or more processors on the main processor module 820. In embodiments, computer-readable instructions executable by one or more processors on the main processor module 820 may receive the wind sensor measurements and/or status parameters and compare these against threshold wind sensor measurements. If the received wind sensor measurements are equal to or greater than a threshold, the computer-readable instructions executable by one or more processors of the main processor module may communicate a warning sound file to the one or more speaker assemblies 826 and/or a warning message to the mobile communication or computing device 872 for display to a user via shading device (umbrella or parasol) operation software (e.g., SMARTSHADE). In embodiments, computer-readable instructions executable by one or more processors may communicate instructions to the one or more wind sensors to capture wind speed measurements and then to communicate the captured wind speed measurements (or wind sensor status parameters) back to the one or more processors. Then, as described above, the received wind sensor measurements may be compared to wind speed threshold measurements as described above. In embodiments, if a measured wind speed is too high, the computer-readable instructions executable by the one or more processors may communicate instructions, messages and/or signals to the motor and pulley assembly 825 to close the umbrella or parasol due to problematic or dangerous conditions.

In embodiments, a lower pulley support assembly 847 may comprise one or more motion detection sensors or distance sensors 851. In embodiments, the motion detection sensors or distance sensors 851 on the lower pulley support assembly 847 may be detecting movement of the arm collar assembly 848 (e.g., by determining how far the arm collar assembly 848 is away from the lower pulley support assembly 847). In embodiments, for example, the motion detection sensors or distance sensors 851 may determine that an arm collar assembly 848 is a first distance from the lower pulley support assembly and that corresponds to the arm support assemblies 850 and arms being fully deployed in an open position. In embodiments, for example, the motion detection sensors or distance sensors may determine that the arm collar assembly 848 is a second, shorted distance from the lower pulley support assembly 847 which corresponds to arm support assemblies 850 and arms 855 being in a closed or retracted position. In embodiments, the one or more motion detection or distance sensors 851 may transmit distance measurements and/or status parameters to one or more processors on the main processor module. In embodiments, computer-readable instructions executable by one or more processors on the main processor module 820 may receive the distance or detection measurements and/or status parameters and compare these against existing distance measurements to determine what position the umbrella or parasol is currently in. In embodiments, the computer-readable instructions executable by one or more processors of the main processor module may communicate an umbrella position message to the mobile communication or computing device 872 for display to a user via shading device (umbrella or parasol) operation software (e.g., SMARTSHADE). In embodiments, computer-readable instructions executable by one or more processors may communicate instructions to the one or more motion detection or distance sensors to capture distance measurements and/or status parameters and then to communicate the captured distance measurements (or sensor status parameters) back to the one or more processors. Then, as described above, the received distance measurements may be compared to existing distance measurements as described above to determine a message to be communicated. Similarly, the one or more sensors 851 on the middle pulley support assembly may measure a distance to one or more arm support assemblies 850 and/or one or more arms 855 and the comparison discussed above may be made with respect to known distances for opening and closing positions between the one or more sensors 851 (on the middle pulley support assembly 847) and the arm support assemblies 850 and/or the one or more arms 855.

In embodiments, the upper pulley support assembly 870 may comprise one or more distance or motion detection sensors 852. In embodiments, operation and use of the one or more distance or motion detection sensors 852 may be similar to the operation discussed above for the one or more sensors 851 on the lower pulley support assembly 870. Thus, the description will not be repeated. In embodiments, the one or more distance or detection sensors 852 on the upper pulley support assembly 870 may be utilized in conjunction with the one or more distance or detection sensors 851 on the lower pulley support assembly 847 in order to determine positions of the arm collar assembly 848, the arm support assemblies 850 and/or the one or more arms 855 (and thus whether the umbrella is opened or closed or partially opened or closed.

In embodiments, the one or more arm support assemblies 850 may comprise one or more motion detection or distance sensors 854. In embodiments, the one or more motion detection or distance sensors 854 may capture sensor measurements or status parameters and communicate such information as described above. In embodiments, the one or more motion detection or distance sensors 854 on the one more arm support assemblies may measure a distance to a ground surface and/or a distance to a center support assembly 807 (and/or even to an automation attachment 810). These distances may be analyzed as discussed above. In addition, the sensors 854 may be gyroscopes and/or accelerometers and may measure an elevation angle or position with respect to a reference point. In embodiments, these directional measurements may assist in determining a position of one or more arm support assemblies 850 with respect to a known position (e.g., are the one or more arm support assemblies 850 at a 45 degree angle (open) or a 22.5 degree angle (partially opened or closed)).

In embodiments, the one or more directional sensors 854 may transmit angular or positional measurements and/or status parameters to one or more processors on the main processor module 820. In embodiments, computer-readable instructions executable by one or more processors on the main processor module 820 may receive the angular or positional measurements and/or status parameters and compare these against existing angular measurements to determine what position the umbrella or parasol is currently in. In embodiments, the computer-readable instructions executable by one or more processors of the main processor module 820 may communicate an umbrella position message to the mobile communication or computing device 872 for display to a user via shading device (umbrella or parasol) operation software (e.g., SMARTSHADE). In embodiments, computer-readable instructions executable by one or more processors may communicate instructions to the one or more directional sensors to capture angular or position measurements and/or status parameters and then to communicate the captured angular or position measurements (or sensor status parameters) back to the one or more processors. Then, as described above, the received distance measurements may be compared to existing distance measurements as described above to determine a message to be communicated. Likewise, the computer-readable instructions executable by one or more processors may then communicate a sound file corresponding to the position of the umbrella or parasol to the one or more speaker assemblies 826 for playback or to the mobile computing device 872 (via one or more wireless communication transceivers) for display via shading device operation software executing and running on the mobile computing device 872.

In embodiments, the one or more arms 855 may comprise one or more motion detection or distance sensors 853. In embodiments, the one or more motion detection or distance sensors 853 may capture sensor measurements or status parameters and communicate such information as described above. In embodiments, the one or more motion detection or distance sensors 853 on the one more arm support assemblies may measure a distance to a ground surface and/or a distance to a center support assembly 807 (and/or even to an automation attachment 810). These distances may be analyzed as discussed above. In addition, the sensors 853 may be gyroscopes and/or accelerometers and may measure an elevation angle or position with respect to a reference point. In embodiments, these directional measurements may assist in determining a position of one or more arms 855 with respect to a known position (e.g., are the one or more arm support assemblies 850 at a 90 degree angle (open) or a 45 degree angle (partially opened or closed)). The one or more directional sensors 853 may operate and communicate with one or more processors in the main processor module 820 of the automation attachment as described above.

In embodiments, the automation attachment 810 may further comprise one or more digital imaging devices 877 such as digital or analog cameras. In embodiments, the one or more digital imaging devices 877 may capture images from an area around an automation attachment 810. In embodiments, the one or more digital imaging devices may be powered via a rechargeable battery integrated within the one or more digital cameras. In embodiments, the one or more digital imaging devices may be powered by a removable rechargeable battery 823 installed within the automation attachment 810. In embodiments, the one or more digital imaging devices 877 may be powered utilizing a rechargeable battery 823 which may or may not receive power from a one or more solar panels or cells 860 (either directly or via a charging assembly). In embodiments, the one or more digital imaging devices 877 may not be movable and may capture images and/or videos from a set orientation. In embodiments, the one or more digital imaging devices 877 may be adjustable because the one or more digital imaging devices 877 may be installed in an adjustment assembly 878 (e.g., such as a gimbal assembly). In these illustrative embodiments, the one or more digital imaging devices 877 may capture images or videos from one or more orientations and these orientations may be adjustable by a user or operator. In embodiments, the one or more digital imaging devices 877 may be integrated within a side of the automation attachment 810. In embodiments, the one or more digital imaging devices 877 may be installed on an outside surface of a side of an automation attachment 810. In embodiments, the one or more digital imaging devices 877 may be integrated within a top of the automation attachment 810 or may be installed on an outside top surface of the automation attachment 810. In embodiments, the one or more buttons 890 may allow operation of the one or more digital imaging devices 877. In embodiments, a motion detector (either integrated within the automation assembly or installed on a surface of the automation attachment) may detect motion in an area around an automation attachment 810 and may communicate an activation signal or instruction to the one or more digital imaging devices 877 to capture images in an environment around the automation attachment 810. In embodiments, computer-readable instructions executable by one or more processors of the main processor module 820 may communicate instructions to the one or more digital imaging devices 877 to activate the device, capture images and/or video and/or to communicate the captured image and/or video back to the main processor module. In embodiments, the captured image and/or video may be communicated via communication buses on the automation attachment (I2C, CAN or other communication protocols). In embodiments, if the one or more digital imaging devices 877 may comprises a wireless communication transceiver (e.g., a Bluetooth transceiver or a BLE transceiver) and thus may communicate with one or more processors on the main processor module via a BLE or Bluetooth wireless communication transceiver. In these illustrative embodiments, the computer-readable instructions may be executed by the one or more processors to communicate the received video or images to the mobile computing device 872 via the BLE transceiver or the Bluetooth transceiver or the WiFi transceiver of the main processor module 820. In embodiments, the one or more digital imaging devices 877 may communicate the captured images or video to the mobile computing device 872 via a BLE transceiver, a Bluetooth (or other PAN) transceiver or the WiFi transceiver (without utilizing the one or more processors of the main processor module). In embodiments, communications may be made utilizing a cellular transceiver. In embodiments, the captured video or images may be displayed within a window of umbrella or shading device operation software executing or running on the mobile computing device (e.g., SMARTSHADE).

In embodiments, a button or control panel 890 or a mobile computing device 872 (or remote computing device or existing computing device like a POS terminal) may communicate and control operations of the one or more imaging devices 877. In embodiments, the mobile computing device 872 (or remote computing device or existing computing device like a POS terminal) may communicate commands or instructions to one or more processors of the main processor module via one or more wireless communication transceivers 415 of the automation attachment 910 in order to control operations of the one or more imaging devices 877. In embodiments, computer-readable instructions executable by the one or more processors may receive the commands or instructions from the mobile computing device 872, may interpret these commands or instructions and may generate commands, instructions and/or signals that are communicated to the one or more imaging devices 877. In embodiments, the one or more imaging devices may receive the generated commands, instructions and/or signals, perform the actions corresponding thereto and may communicate back sound, images, and/or video (as well as status parameters and measurements) to the one or more processors in the main processor module 820, which in turn may communicate, to the mobile computing device 872 via one or more wireless communication transceivers 415, the received sound, images and/or video (along with status parameters and/or measurements). In embodiments, the received sound, images and/or video (along with status parameters and/or measurements) may be displayed or presented in application software executing or running on the mobile computing device 872 (or remote computing device or existing computing device like a POS terminal).

FIG. 9A illustrates a block diagram of an automation assembly according to embodiments. In embodiments, an automation assembly 900 is connected to a center support pole or a parasol pole 905. In embodiments, an automation assembly 900 may comprise one or more main processors module 910, a control panel 920, one or more battery compartments 930, one or more motor and pulley assemblies 932 and/or 934, one or more wind sensors 950, one or more speaker assemblies 951, and one or more locking systems or assemblies 906 and/or 908 (which are discussed in detail in FIG. 3E). In embodiments, an automation assembly 900 may comprise a universal serial bus (USB) interface port 947 and/or a power charging port 946 (which may allow an automation attachment to receive DC power from an external source (e.g., a wall outlet).

In embodiments, the automation attachment 900 may comprise two pieces or halves. In embodiments, the automation attachment 900 may be connected, coupled or attached to the parasol or umbrella pole 905 utilizing one or more top locking systems 906 and/or one or more bottom locking systems 908. In embodiments, different diameter center support or parasol poles 905 may be accommodated by utilizing one or more adaptors 907 which change a width or opening size of a top portion and/or a bottom portion of the automation attachment. FIGS. 3A-3E describes attachment locking systems and/or adapters in more detail. In embodiments, the one or more adapters 907 may be made of a rubber material.

In embodiments, a control panel 920 may comprise one or more buttons to control operation of the automation attachment 900. In embodiments, such as illustrated in FIG. 9A, the control panel 920 may comprise one or more power buttons 921, one or more personal area network (PAN) communications buttons 922, one or more open parasol buttons 923, one or more close parasol buttons 924, and/or one or more audio volume buttons. In embodiments, the control panel 920 may further comprise one or more light buttons 925 and/or one or more parasol linking buttons 926. In embodiments, the one or more power buttons 921 may turn on or off power in the automation attachment 910. In embodiments, the one or more PAN buttons 922 may allow activation or deactivation of PAN communication transceivers (e.g., Bluetooth, Zigbee, Z-wave) in the automation attachment 900. Other buttons may be added to the control panel to control activation or deactivation of other wireless communication transceivers (e.g., WiFi transceivers and/or cellular transceivers). In embodiments, one or more buttons may also be included in the automation attachment 900 to turn on local area network (LAN) wireless communications and/or cellular wireless communications via associated wireless transceivers that are also included or installed in the automation attachment 900.

In embodiments, the one or more parasol open buttons 923 may allow manual operation and/or activation of opening of a parasol to which the automation attachment is connected. In embodiments, the one or more open buttons 923 may communicate directly, or indirectly, with the one or more motor 945 and pulley assemblies 932 and/or 943 to open the parasol. In embodiments, the one or more close buttons 924 may allow manual operation to close a parasol to which the automation attachment 910 is attached. In embodiments, the one or more close buttons 924 may communicate directly, or indirectly, with one or more motor 945 and pulley assemblies 932 and/or 943 to close the parasol. In embodiments, the one or more volume buttons may be utilized to increase or decrease the volume of audio projected, reproduced or emitted from the one or more speaker assemblies 951. In embodiments, the one or more volume buttons may communicate directly to the one or more speaker assemblies 951 or, alternatively, through the one or main processor boards or circuitry 910. These buttons allow manual control but automatic operation of the open and closing of the parasol umbrella as well turning on and off the parasol via the buttons.

In embodiments, the one or more light buttons 925 may communicate with lighting assemblies integrated within the automation attachment and/or with lighting assemblies that may be in communication with the automation attachment. In embodiments, the one or more lighting buttons 925 may communicate, indirectly or directly, to the lighting assemblies inside of and/or external to the automation attachment 900. In embodiments, the one or more parasol linking buttons 926 may allow one parasol to communicate instructions, commands, signals, videos, images and/or sound files to other automation attachments connected to other parasols. In embodiments, the one or more parasol linking buttons 926 may communicate with the processor module (e.g., such as the main processor board 910). In embodiments, computer-readable instructions executable by the one or more processors of the processor module may receive that the parasol linking button has been pushed and may communicate with the one or more wireless communication transceivers that the parasol may now be utilized as a wireless communication hub and may communicate instructions, commands, measurements, parameters and/or signals (e.g., via the one or more wireless communication transceivers) to other automated umbrellas and/or other parasols with automation attachments.

In embodiments, the battery compartment 930 may comprise one or more rechargeable batteries. In embodiments, the rechargeable batteries in the battery compartment may be removable from the automation attachment 900. In embodiments, the rechargeable batteries in the battery compartment 930 may also be rechargeable via the power charging port 946 and/or via one or more solar panels (not shown).

In embodiments, the one or more wind sensors 950 may be positioned so that portion or part of the wind sensor can receive wind from an outside environment. In embodiments, one or more wind sensors 950 may be installed in an opening of an outer surface of the automation attachment 900. In embodiments, a screen may be placed over an opening in the surface of the automation attachment in order to keep large objects from entering an interior of the one or more wind sensors 950 and damaging the one or more wind sensors 950 or other components of the automation attachment 900. In embodiments, the one or more wind sensors may capture wind speed measurements (as described previously) and communicate such measurements to the main processor module and/or to a mobile computing device (or other external computing device).

In embodiments, the one or more speaker assemblies 951 may reproduce sound communicated or transmitted from components on the one or more main processors boards (e.g., via a wireless communication transceiver (e.g., a Bluetooth transceiver) installed on the one or more main processor board 910). In embodiments, there may be two speaker assemblies, three speaker assemblies 951, or four speaker assemblies 951 in the automation attachment 900. FIGS. 6A and 6B describe placement and utilization of the speaker assemblies in the automation attachment.

In embodiments, the USB interface port 947 may provide power to mobile communication devices having a USB interface or cable that are attached to the automation attachment 910. In embodiments, the USB interface port 947 may comprise one or more connectors to provide power to one or more mobile communication devices that are connected or attached to the one or more connectors of the USB interface power 947 via, for example, USB cables.

In embodiments, the automation attachment 900 may comprise one or more power charging ports 946. In embodiments, an external power source (e.g., a generator or an AC wall outlet) may connect to the one or more power charging ports 946 and provide external power to the automation attachment 900 (and thus the one or more rechargeable batteries in the battery compartment 930). In embodiments, an adapter may be utilized to convert the AC power from the wall outlet (or other AC power source) to DC power supplied to the one or more power charging ports 947 of the automation attachment. In embodiments, the one or more power charging ports 946 may be connected directly to the one or more rechargeable batteries in the battery compartment 930. In embodiments, the one or more power charging port may provide power to the one or more rechargeable batteries and/or other components or assemblies utilizing, for example, an electrical cord that transfers data, control signals and/or power.

In embodiments, one or more motor and pulley assemblies may control opening or closing of a frame or arms of a parasol to which the automation assembly 900 is attached. In embodiments, the one or more motor and pulley assemblies may comprise one or more motors 945, one or more right angle gearboxes 940, one or more tubular rods or shafts 937, one or more pulleys 932 (a center pulley) and 943 (an outer pulley), and/or one or more cables, ropes, cables or strings 936 (an inner rope) and 944 (an outer rope). In embodiments, the one or more motors 945 may comprise a motor controller (not shown) and may receive communications, instructions and/or signals from one or more processors on the one or more main processors boards 910. In embodiments, the one or more main processor boards 910 may comprise one or more motor controllers to generate commands, instructions and/or signals that are to transmitted or communicated to one or more motors 945.

In embodiments, the automation kit or attachment 900 may be utilized with parasols having an internal string or rope assembly (e.g., a string inside center support or a parasol pole) as well as parasols that have has string or rope assembly on an outside of a center support or parasol pole 907. In embodiments, where the parasol had an existing internal rope assembly (most likely with a hand crank assembly), the motor and pulley assembly may comprise a shaft or tubular rod 937, an internal pulley assembly 932, a rope, string or cable 936, a right-angle gearbox 940 and/or one or more motors 945. In embodiments, a hand crank in the existing manual umbrella may be removed (including a handle). In embodiments, an internal pulley assembly 932 may be removable. In embodiments, an internal pulley assembly 932 may be attached to a shaft or tubular rod 937 via a magnet or ball bearing (e.g., similar to a ratchet). In embodiments, a pulley or hub included with the hand crank assembly may also be replaced. In embodiments, a pulley or hub existing in the parasol (e.g., parasol pole) may be utilized if it can interface with and/or be coupled to the shaft or tubular rod 937 of the automation attachment. In embodiments, a shaft 937 and a center pulley assembly 932 may be inserted into the existing holes in the center support or parasol pole 905. In embodiments, the shaft 937 and center pulley assembly 932 may be installed perpendicular to a vertical axis of the parasol pole 905. In other words, the shaft or tubular rod 937 and center pulley assembly 932 may be installed along a horizontal axis that is parallel with a flat ground surface. In embodiments, a shaft 937 may be held in place with a pin or other connector on one side of the automation attachment next to the parasol pole. In embodiments, an end of a rope or cable 936 may be attached to or be wound around the center pulley assembly 932 and an opposite end of the rope or cable 936 then may be further attached to and travel around an upper support assembly (e.g., see FIG. 2). In embodiments, the rope or cable 936 may then be attached to an arm collar assembly of the parasol or umbrella to lift the arms or frame of the existing frame.

In embodiments, the motor 945 may be activated or turned on and may rotate an output shaft which is connected to a right angle gearbox 940. In embodiments, the shaft 937 may be connected and/or coupled to the right angle gearbox 940. In embodiments, the rotation of the motor shaft may cause rotation of gears in the right angle gearbox 940, which in turn causes rotation of the shaft or tubular rod 937. In embodiments, a rotation of the shaft or tubular rod 937 causes the attached or connected center pulley 932 to rotate which in turn causes the rope to wind or unwind. In embodiments, winding or unwinding of the rope or cable 936 (which results in opening or closing of the parasol or umbrella (as described earlier in the specification).

In embodiments, a motor shaft 939 may rotate after a motor 945 has been turned on, which causes rotation of gearing assembly 941 (which is part of the right angle gearbox). In embodiments, the gearing assembly 941 may be connected or coupled to gearing assembly 942. In embodiment, gearing assembly 941 may be connected at a right angle to gearing assembly 942, which changes an axis of rotation. In embodiments, gearing assembly 942 may be connected and/or coupled to shaft or tubular rod 937 and causes the shaft or rod 937 to rotate. In embodiments, the gearing assembly 942 may be positioned around and connected or coupled to the shaft or rod. In this illustrative embodiment, the shaft 937 may rotate, which causes the center pulley 932 to rotate and the rope or cable 936 to wind or unwind.

In embodiments, a parasol or umbrella may have an existing rope or cable that is connected to a center hub arm expansion assembly to allow for manual opening or closing of the parasol frame. The exiting rope or cable may be located outside the parasol pole 905. In these embodiments, the automation assembly 910 may also be utilized to automate such a configuration and allow automatic operation of an existing manual umbrella with an outside rope. In embodiments, the automation attachment and specifically the motor and pulley assembly may include a shaft 937, a right angle gearbox 940, an outer pulley assembly 943 and/or a rope or cable 944. In embodiments, because there is no hand crank or rope inside a parasol pole 905, the shaft 937 may only be located in the automation attachment 900. In embodiments, the shaft 937 may travel through the center support or parasol pole 905 but does not have to. In embodiments, the outer pulley assembly 943 may be connected or coupled to the shaft or rod 937 either directly or indirectly (e.g., ball bearing and/or magnetic connection). In embodiments, as discussed above, the shaft 937 may rotate based on activation of the motor and the interconnection of the motor shaft 939 with the right angle gear box 940. The rotation of the shaft 937 causes rotation of the outer pulley assembly 943, which in turn causes rotation and/or winding/unwinding of the outside rope or cable 944. As discussed previously, the winding/unwinding of the outside rope or cable 944 causes movement of the coupled arm collar assembly and expansion or retracting of the arms or frame of the existing parasol or umbrella.

The automation attachment is an advancement to allow automation of the large number of manual umbrellas that are in the marketplace. As described herein, the automation attachment includes a number of features to allow users of existing manually-operated umbrellas to not only automate opening and closing of the umbrella, but also have the umbrella or parasol communicate with other electronic devices utilizing a number of wireless communication technologies and transceivers. In embodiments, the automation attachment may also comprise one or more imaging devices, one or more sensor devices, include voice recognition and allow music files to be reproduced utilizing integrated speaker assemblies. In addition, the automation attachment described herein has the ability to not only automate manually operated umbrellas configured with hand crank assemblies (and inside rope and pulley assemblies) but also to automate manually operated umbrellas utilizing a rope on an outside or a parasol pole or center support assembly 905. In embodiments, one half of the automation assembly 900 may comprise a hinged panel or removable panel to allow access to certain components or assemblies of the automation attachment. In embodiments, a hinged panel or removable panel may allow access to add, adjust or remove components or assemblies of the motor and pulley assembly. In embodiments, a hinged panel or removable panel may allow access to one or more USB ports 937 (which may be hidden from view), one or more charging power charging ports 936 and/or one or more battery compartments 930.

FIG. 9A illustrates additional components of an automation assembly according to embodiments. In FIG. 9A, the automation assembly includes a top locking system 906 and a bottom locking system 908 which are discussed in detail in FIG. 3E. In embodiments, the top locking system 906 attaches to a top portion of the parasol pole 907. In embodiments, the bottom locking system 908 attaches to a bottom portion of the parasol pole 907. In embodiments, the automation attachment further includes a voice module 990. In embodiments, the voice module 990 may comprise one or more microphones to capture audio commands spoken by a user or operator. In embodiments, the one or more microphones may be a microphone line array. In embodiments, the voice module 990 may also comprise an integrated chip or a printed circuit board including one or more processors, one or more memory devices and/or computer-readable instructions stored in the one or more memory devices. In embodiments, the computer-readable instructions executable by the one or more processors may receive the audio sounds, convert the audio sounds into audio files and analyze the audio files to determine if any voice umbrella commands may be recognized. In this embodiment, if the audio files are recognized as umbrella commands, the computer-readable instructions may be executable by the one or more processors may communicate commands, instructions or signals to the component or assembly that corresponds to the recognized voice commands. Similarly, the computer-readable instructions executable by the one or more processors may communicate the received audio files to a third-party voice recognition server. In embodiments, recognized parasol commands may also be communicated to the main processors board 910, where computer-readable instructions executable by one or more processors may communicate with components and/or assemblies of the automation attachment (e.g., sensors, motors, audio transceivers and/or speakers).

In embodiments, if one or more cameras are added to the automation attachment, the Bluetooth transceivers 417 may be utilized to bi-directionally communicate commands or instructions to the camera and captured sound or video or images to other components or assemblies in the automation attachment or to external computing devices (e.g., such as servers, other external computing devices, and/or mobile computing devices 272). In embodiments, if microphones are utilized to captured audio from an environment around the umbrella or from a user or operator, then the one or more Bluetooth transceivers 417 may be utilized to communicate commands to the microphones 285 and to transmit captured audio files that were captured by the one or more microphones 285.

In embodiments, the automation attachment may also include a camera module 992 which may include one or more cameras. In embodiments are added to the automation attachment, LAN or WiFi transceivers may be utilized to bi-directionally communicate commands or instructions to the one or more cameras to activate or deactivate the one or more cameras to begin or stop capturing images, videos and/or sound. In embodiments, the camera module may communicate captured sound or video or images to other components or assemblies (e.g., main processor board 910 or main processor module) or to external computing devices (e.g., such as servers and/or mobile computing devices). In embodiments, the camera module 992 may be able to rotate around the parasol pole 907.

FIG. 9B illustrates a front view of an automation attachment according to embodiments. In embodiments, the automation attachment may be comprised of three sections, an automation attachment body 909, a top cap or top connection attachment 906, and a bottom cap or bottom connection attachment 908. In embodiments, the automation attachment body 909 is positioned on the parasol pole 905 by sliding the automation attachment body 909 up or down the parasol pole 905. In embodiments, the top cap or top connection attachment 906 is screwed or twisted onto the automation attachment body 909 as described in FIG. 3E. In embodiments, the bottom cap or bottom connection attachment 908 is screwed or twisted onto the automation attachment body 909. In embodiments, the automation attachment body 909 may comprise a control panel with one or more buttons or switches located on an outer surface of the automation attachment body 909. In embodiments, the one or more buttons or switches may comprise a power button 921, an open button 923, a close button 924, a personal area network transceiver (or Bluetooth) button 922, a lighting assembly or lights button 925 and/or a parasol linking button 926, the operations of which have been described above. In embodiments, the automation attachment body 909 may comprises one or more speaker assemblies 951. FIG. 9C illustrates a side view of an automation attachment according to embodiments. In addition to the control panel, an automation attachment body 909 may comprise an “on” indicator light 927 identifying that power is available and/or being utilized in the automation attachment.

FIG. 9D illustrates an automation attachment attached to an umbrella or parasol according to embodiments. FIG. 9D illustrates positioning of an automation attachment on an existing umbrella. In embodiments, an existing umbrella may comprise a base assembly 990, a center support assembly or pole 905, and an umbrella frame 995 (on which shading fabric may rest to provide shade to a user). As illustrated in FIG. 9D, the automation attachment 900 may be positioned about halfway up a center support pole and be attached to the center support pole 905. In embodiments, the automation attachment 900 may comprise a top cap or top connection assembly 906, an automation attachment body 909, and a bottom cap or bottom connection assembly 908. In embodiments, the automation attachment 900 (e.g., the automation attachment body 909) may comprise one or more speaker assemblies 951. FIG. 9E illustrates an automation attachment attached to an umbrella including an elevation joint or hinge according to embodiments. FIG. 9E illustrates positioning of an automation attachment on an existing umbrella which has an elevation joint to change orientation of the center umbrella frame 995 with respect to a user. FIG. 9E illustrates that an upper hinge or joint 991 may connect an upper support pole or assembly 992 to a center support pole or assembly 905 to allow the umbrella frame 995 move to different positions during a day and provide shade to a user of the umbrella. In the embodiment illustrated in FIG. 9E, the automation attachment 900 is connected or coupled to the umbrella frame 995 to control opening and closing of the existing parasol or umbrella.

In embodiments, an automatically controlled umbrella system may comprise an existing non-automated umbrella including an umbrella base, an umbrella pole and an umbrella frame; an automation attachment connected to the umbrella frame to automate the opening or closing of the umbrella frame; and a mobile computing device. The mobile computing device may comprise one or more processors; one or more memory devices; one or more wireless communication transceivers; and computer-readable instructions stored in the one or more memory devices, where the computer-readable instructions executable by the one or more processors to communicate instructions, commands or messages to the automation attachment via the one or more wireless communication transceivers to open or close the umbrella frame. In embodiments, the automation attachment may include one or more processors, one or more memory devices and computer-readable instructions stored in the one or more memory devices, the computer-readable instructions executable by the one or more processors to control operation of the automation attachment. In embodiments, the automation attachment may further include one or more wireless communication transceivers and one or more motor and pulley assemblies, wherein the one or more wireless communication transceivers receives the instructions, commands or messages communicated by the mobile computing device and the computer-readable instructions are executable by the one or more processors to communicate signals, commands or instructions to the one or more motor and pulley assemblies to cause the umbrella frame to open or close.

In embodiments, the automation attachment may include one or more speakers, and the computer-readable instructions executable by the one or more processors on the mobile computing device may communicate, via the one or more wireless communication transceivers of the mobile computing device, instructions, messages or commands to the automation attachment to play audio files utilizing the one or more speakers of the automation attachment. In embodiments, the computer-readable instructions executable by the one or more processors on the mobile computing device may communicate, via the one or more wireless communication transceivers of the mobile computing device, the audio files that are to be played on the one or more speakers of the automation attachment. In embodiments, the automation attachment further comprising one or more lighting elements or assemblies; and the computer-readable instructions executable by the one or more processors on the mobile computing device may communicate, via the one or more wireless communication transceivers of the mobile computing device, instructions, messages or commands to the automation attachment to activate or deactivate the one or more lighting elements or assemblies of the automation attachment.

In embodiments, the automation attachment may include one or more environmental sensor assemblies to capture environmental measurements of an area around the automation attachment; and the computer-readable instructions executable by the one or more processors on the mobile computing device may communicate, via the one or more wireless communication transceivers of the mobile computing device, instructions, messages or commands to the automation attachment to activate the one or more environmental sensor assemblies of the automation attachment and to cause the one or more environmental sensor assemblies to capture environmental sensor measurements around the umbrella. In embodiments, the one or more environmental sensor assemblies include at least one of the following: a wind sensor, a temperature sensor, a humidity sensor, a lightning sensor, a rain sensor, or an air quality sensor. In embodiments, the computer-readable instructions may be executable by the one or more processors of the automation attachment and may communicate the captured sensor measurements, via the one or more wireless communication transceivers of the automation attachment, to the mobile computing device. In embodiments, the automation attachment may further include one or more direction sensor assemblies to capture directional measurements of the automation attachment; and the computer-readable instructions executable by the one or more processors on the mobile computing device may communicate, via the one or more wireless communication transceivers of the mobile computing device, instructions, messages or commands to the automation attachment to activate the one or more direction sensor assemblies of the automation attachment and to cause the one or more direction sensor assemblies to capture the directional measurements. In embodiments, the computer-readable instructions are executable by the one or more processors of the automation attachment may communicate the captured directional measurements, via the one or more wireless communication transceivers of the automation attachment, to the mobile computing device. In embodiments, the direction sensors may comprise gyroscopes, accelerometers, GPS receivers, or a digital compass.

In embodiments, the automation attachment may further include one or more camera modules to capture images or videos of an area around the automation attachment; and the computer-readable instructions executable by the one or more processors on the mobile computing device may communicate, via the one or more wireless communication transceivers of the mobile computing device, instructions, messages or commands to the automation attachment to activate the one or more camera modules of the automation attachment and to cause the one or more camera modules to capture the images or videos of the area around the automation attachment. In embodiments, the computer-readable instructions executable by the one or more processors of the automation attachment may communicate the captured images or videos, via the one or more wireless communication transceivers of the automation attachment, to the mobile computing device. In embodiments, the automation attachment may include removable battery assemblies; and the computer-readable instructions executable by the one or more processors on the mobile computing device may communicate, via the one or more wireless communication transceivers of the mobile computing device, instructions, messages or commands to the automation attachment to retrieve power related parameters of the one or more removable battery assemblies of the automation attachment. In embodiments, the automation attachment may include one or more solar panels coupled to the automation attachment; and the computer-readable instructions executable by the one or more processors on the mobile computing device may communicate, via the one or more wireless communication transceivers of the mobile computing device, instructions, messages or commands to the automation attachment to retrieve power related parameters from the one or more solar panels of the automation attachment. In embodiments, the computer-readable instructions executable by the one or more processors of the automation attachment may communicate the retrieved power related parameters from the one or more solar panels, via the one or more wireless communication transceivers of the automation attachment, to the mobile computing device.

Non-volatile storage medium/media is a computer readable storage medium(s) that can be used to store software and data, e.g., an operating system, system programs, device drivers, and one or more application programs, in a computing device or one or more memory devices of a balcony shading and power system processor, controller and/or computing device. Persistent storage medium/media also be used to store device drivers, (such as one or more of a digital camera driver, motor drivers, speaker drivers, scanner driver, or other hardware device drivers), web pages, content files, metadata, playlists, data captured from one or more assemblies or components (e.g., sensors, cameras, motor assemblies, microphones, audio and/or video reproduction systems) and other files. Non-volatile storage medium/media can further include program modules/program logic in accordance with embodiments described herein and data files used to implement one or more embodiments of the present disclosure.

A computing device or a processor or controller may include or may execute a variety of operating systems, including a personal computer operating system, such as a Windows, iOS or Linux, or a mobile operating system, such as iOS, Android, or Windows Mobile, Windows Phone, Google Phone, Amazon Phone, or the like. A computing device, or a processor or controller in a balcony shading and power system controller may include or may execute a variety of possible applications, such as a software applications enabling communication with other devices, such as communicating one or more messages such as via email, short message service (SMS), or multimedia message service (MMS), FTP, or other file sharing programs, including via a network, such as a social network, including, for example, Facebook, LinkedIn, Twitter, Flickr, or Google+ and/or Instagram provide only a few possible examples. A computing device or a processor or controller in a balcony shading and power system may also include or execute an application to communicate content, such as, for example, textual content, multimedia content, or the like. A computing device or a processor or controller in a balcony shading and power system may also include or execute an application to perform a variety of possible tasks, such as browsing, searching, playing various forms of content, including locally stored or streamed content. The foregoing is provided to illustrate that claimed subject matter is intended to include a wide range of possible features or capabilities. A computing device or a processor or controller in a balcony shading and power system and/or mobile computing device may also include imaging software applications for capturing, processing, modifying and transmitting image, video and/or sound files utilizing the optical device (e.g., camera, scanner, optical reader) within a mobile computing device and/or a balcony shading and power system.

For the purposes of this disclosure a computer readable medium stores computer data, which data can include computer program code that is executable by a computer, in machine-readable form. By way of example, and not limitation, a computer-readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, DRAM, DDRAM, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof

The above disclosure is sufficient to enable one of ordinary skill in the art to practice the invention and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. An automatically controlled umbrella system, comprising:
an existing non-automated umbrella including an umbrella base, an umbrella pole and an umbrella frame;
an automation attachment connected to the umbrella frame to automate the opening or closing of the umbrella frame; and
a mobile computing device, the mobile computing device comprising:
one or more processors;
one or more memory devices;
one or more wireless communication transceivers;
computer-readable instructions stored in the one or more memory devices, the computer-readable instructions executable by the one or more processors to communicate instructions, commands or messages to the automation attachment via the one or more wireless communication transceivers to open or close the umbrella frame.

2. The automatically controlled umbrella system of claim 1, wherein the automation attachment comprises one or more processors, one or more memory devices and computer-readable instructions stored in the one or more memory devices, the computer-readable instructions executable by the one or more processors to control operation of the automation attachment.

3. The automatically controlled umbrella system of claim 2, wherein the automation attachment further comprises one or more wireless communication transceivers, and one or more motor and pulley assemblies, wherein the one or more wireless communication transceivers receives the instructions, commands or messages communicated by the mobile computing device and the computer-readable instructions are executable by the one or more processors to communicate signals, commands or instructions to the one or more motor and pulley assemblies to cause the umbrella frame to open or close.

4. The automatically controlled umbrella system of claim 2, the automation attachment including one or more speakers, and
the computer-readable instructions executable by the one or more processors on the mobile computing device to communicate, via the one or more wireless communication transceivers of the mobile computing device, instructions, messages or commands to the automation attachment to play audio files utilizing the one or more speakers of the automation attachment.

5. The automatically controlled umbrella system of claim 4, the computer-readable instructions executable by the one or more processors on the mobile computing device to communicate, via the one or more wireless communication transceivers of the mobile computing device, the audio file that are to be played on the one or more speakers of the automation attachment.

6. The automatically controlled umbrella system of claim 2, the automation attachment further comprising one or more lighting elements or assemblies; and
the computer-readable instructions executable by the one or more processors on the mobile computing device to communicate, via the one or more wireless communication transceivers of the mobile computing device, instructions, messages or commands to the automation attachment to activate or deactivate the one or more lighting elements or assemblies of the automation attachment.

7. The automatically controlled umbrella system of claim 2, the automation attachment further comprising one or more environmental sensor assemblies to capture environmental measurements of an area around the automation attachment; and
the computer-readable instructions executable by the one or more processors on the mobile computing device to communicate, via the one or more wireless communication transceivers of the mobile computing device, instructions, messages or commands to the automation attachment to activate the one or more environmental sensor assemblies of the automation attachment and to cause the one or more environmental sensor assemblies to capture environmental sensor measurements.

8. The automatically controlled umbrella system of claim 7, wherein the one or more environmental sensor assemblies include at least one of the following: a wind sensor, a temperature sensor, a humidity sensor, a lightning sensor, a rain sensor, or an air quality sensor.

9. The automatically controlled umbrella system of claim 7, wherein the computer-readable instructions are executable by the one or more processors of the automation attachment to communicate the captured sensor measurements, via the one or more wireless communication transceivers of the automation attachment, to the mobile computing device.

10. The automatically controlled umbrella system of claim 2, the automation attachment further comprising one or more direction sensor assemblies to capture directional measurements of the automation attachment; and
the computer-readable instructions executable by the one or more processors on the mobile computing device to communicate, via the one or more wireless communication transceivers of the mobile computing device, instructions, messages or commands to the automation attachment to activate the one or more direction sensor assemblies of the automation attachment and to cause the one or more direction sensor assemblies to capture the directional measurements.

11. The automatically controlled umbrella system of claim 10, wherein the computer-readable instructions are executable by the one or more processors of the automation attachment to communicate the captured directional measurements, via the one or more wireless communication transceivers of the automation attachment, to the mobile computing device.

12. The automatically controlled umbrella system of claim 10, wherein the direction sensors comprise one of the following: gyroscopes, accelerometers, GPS receivers, or a digital compass.

13. The automatically controlled umbrella system of claim 2, the automation attachment further comprising one or more camera modules to capture images or videos of an area around the automation attachment; and
the computer-readable instructions executable by the one or more processors on the mobile computing device to communicate, via the one or more wireless communication transceivers of the mobile computing device, instructions, messages or commands to the automation attachment to activate the one or more camera modules of the automation attachment and to cause the one or more camera modules to capture the images or videos of the area around the automation attachment.

14. The automatically controlled umbrella system of claim 13, wherein the computer-readable instructions are executable by the one or more processors of the automation attachment to communicate the captured images or videos, via the one or more wireless communication transceivers of the automation attachment, to the mobile computing device.

15. The automatically controlled umbrella system of claim 2, the automation attachment further comprising one or more removable battery assemblies; and
the computer-readable instructions executable by the one or more processors on the mobile computing device to communicate, via the one or more wireless communication transceivers of the mobile computing device, instructions, messages or commands to the automation attachment to retrieve power related parameters of the one or more removable battery assemblies of the automation attachment

16. The automatically controlled umbrella system of claim 2, the automation attachment further comprising one or more solar panels coupled to the automation attachment; and
the computer-readable instructions executable by the one or more processors on the mobile computing device to communicate, via the one or more wireless communication transceivers of the mobile computing device, instructions, messages or commands to the automation attachment to retrieve power related parameters from the one or more solar panels of the automation attachment.

17. The automatically controlled umbrella system of claim 16, wherein the computer-readable instructions are executable by the one or more processors of the automation attachment to communicate the retrieved power related parameters from the one or more solar panels, via the one or more wireless communication transceivers of the automation attachment, to the mobile computing device.

18. The automatically controlled umbrella system of claim 1, wherein the automation attachment comprises a top cap, an automation attachment body, and a bottom cap, wherein the top cap twists onto the automation attachment body in order to tighten the automation attachment body and the top cap against the parasol pole and wherein the bottom cap twists onto the automation attachment body in order to tighten the automation attachment body and the bottom cap against the parasol pole.

19. The automatically controlled umbrella system of claim 1, wherein a top end of the automation attachment body comprises one or more ridges, a collet body and one or more collet arms, and the top cap comprises recessed channels, wherein when the top cap is twisted onto the automation attachment body, the recessed channels mate with the one or more ridges, and wherein the collet body and the one or more collet arms are pressed inward against the parasol pole to press the automation attachment body against the parasol pole.

20. The automatically controlled umbrella system of claim 1, wherein a bottom end of the automation attachment body comprises one or more ridges, a collet body and one or more collet arms, and the bottom cap comprises recessed channels, wherein when the bottom cap is twisted onto the automation attachment body, the recessed channels mate with the one or more ridges, and wherein the collet body and the one or more collet arms are pressed inward against the parasol pole to press the automation attachment body against the parasol pole.
